(19) United States
(12) Patent Application Publication
(10) Pub. No.: US 2016/0041722 A1
(43) Pub. Date: Feb. 11, 2016

(54) SYSTEMS AND METHODS FOR PROCESSING ORDERS OF CONTENT ITEMS

(71) Applicant: Facebook, Inc., Menlo Park, CA (US)

(72) Inventors: Jinpeng Ren, Mountain View, CA (US); Akash Gaurav Gupta, Los Altos, CA (US); Shi Xu, Santa Clara, CA (US); Kejia Zhu, San Francisco, CA (US)

(21) Appl. No.: 14/455,672

(22) Filed: Aug. 8, 2014

(51) Int. Cl. G06F 3/0484; G06F 3/0485; G06F 3/0488; G06K 9/20

(52) U.S. Cl. CPC G06F 3/04842; G06K 9/2054; G06F 3/0485; G06F 3/04883

(57) ABSTRACT

Various embodiments of the present disclosure can include systems, methods, and non-transitory computer readable media configured to highlight, by a computing system, a reference content item of a plurality of content items associated with a story in response to a selection of the reference content item, the plurality of content items having a first order. The reference content item may be reranked relative to the plurality of content items in response to user input to create a second order of the plurality of content items. The story may be published using the second order of the plurality of content items.

### FIELD OF THE INVENTION

The present technology relates to the field of multimedia content. More particularly, the present technology provides techniques for selecting content items and generating multimedia content.

### BACKGROUND

Computing devices are popular and are often used to browse web sites, access online content, interact with social networks and/or social media, and perform a wide variety of tasks. Computing devices may allow users to create and upload content items to a social networking or social media services, where other users can comment, like, and/or further share the content items.

When selecting content items for uploading, computing devices typically link users to a camera coupled to/integrated into the computing device, a local file system, or a remote file system connected to the computing device with a network connection. Facilitating links to cameras and local files systems allow a user the flexibility of uploading content items that were recently captured or are otherwise located on the user's computing device. Facilitating links to a remote file system allows the user to upload content items stored on networked devices, including cloud storage accounts and other servers accessible via networks. Systems that make it easier to upload and organize content items would be helpful.

### SUMMARY

Various embodiments of the present disclosure can include systems, methods, and non-transitory computer readable media configured to highlight, by a computing system, a reference content item of a plurality of content items associated with a story in response to a selection of the reference content item, the plurality of content items having a first order. The reference content item may be reranked relative to the plurality of content items in response to user input to create a second order of the plurality of content items. The story may be published using the second order of the plurality of content items.

In some embodiments, the first order corresponds to an order the content items were uploaded for the story. Moreover, a content reordering screen may be generated in response to the selection of the reference content item in a story creation screen. The content reordering screen may display at least a portion of the plurality of content items in a vertical format optimized for viewing in a viewport of a mobile device.

In an embodiment, each of the plurality of content items comprises one or more of: digital images, digital audio, digital video, map data, hashtags, and social tags. The plurality of content items may be scrolled in a content reordering screen. The scrolling may occur at scrolling speeds based at least in part on a distance between a position of a cursor or touchpoint and an initial position of the reference content item.

In an embodiment, reranking the reference content item comprises: identifying an initial rank of the reference content item; identifying an insertion location between a first content item and a second content item into which the user input instructs insertion of the reference content item; and updating the rank of the reference content item based at least in part on the identified insertion location. A rank of at least a portion of the plurality of content items other than the reference content item may be updated.

In an embodiment, highlighting the reference content item comprises shading the reference content item in a content reordering screen.

In an embodiment, the selection comprises a long press. The selection may comprise a double-click or a right-click. Further, publishing the story may comprise at least one of sharing the story, publishing the story in a feed, storing the story locally, or storing the story on a server.

In an embodiment, selection of the reference content item is associated with a first screen and reranking of the reference content item is associated with a second screen. The user input may be applied to a touchscreen display. The computer-implemented method may be implemented on a mobile device. Further, the computer-implemented method is implemented on an application associated with a social networking service or a social media service.

Many other features and embodiments of the invention will be apparent from the accompanying drawings and from the following detailed description.

### BRIEF DESCRIPTION OF THE DRAWINGS

FIG. 1 illustrates an example environment including a story publication system, according to an embodiment of the present disclosure.

FIG. 2 illustrates an example environment including a story publication user interface module, according to an embodiment of the present disclosure.

FIG. 3 illustrates an example environment including a user input processing module, according to an embodiment of the present disclosure.

FIG. 4 illustrates an example environment including a display view rendering module, according to an embodiment of the present disclosure.

FIG. 5 illustrates an example environment including a story publication management module, according to an embodiment of the present disclosure.

FIG. 6 illustrates an example environment including a story content order modification module, according to an embodiment of the present disclosure.

FIG. 7 illustrates an example method for reordering content items in a story with a user interface, according to an embodiment of the present disclosure.

FIG. 8 illustrates an example method for reordering content items in a story with a user interface, according to an embodiment of the present disclosure.

FIG. 9 illustrates an example method for reordering content items in a story, according to an embodiment of the present disclosure.

FIG. 10 illustrates an example method for reordering content items in a story, according to an embodiment of the present disclosure.

FIG. 11 illustrates an example screen of a user interface of a system that facilitates reordering of content items, according to an embodiment of the present disclosure.

FIG. 12 illustrates an example screen of a user interface of a system that facilitates reordering of content items, according to an embodiment of the present disclosure.

FIG. 13 illustrates an example screen of a user interface of a system that facilitates reordering of content items, according to an embodiment of the present disclosure.

FIG. 14 illustrates an example screen of a user interface of a system that facilitates reordering of content items, according to an embodiment of the present disclosure.

FIG. 15 illustrates an example screen of a user interface of a system that facilitates reordering of content items, according to an embodiment of the present disclosure.

FIG. 16 illustrates an example screen of a user interface of a system that facilitates reordering of content items, according to an embodiment of the present disclosure.

FIG. 17 illustrates an example screen of a user interface of a system that facilitates reordering of content items, according to an embodiment of the present disclosure.

FIG. 18 illustrates an example screen of a user interface of a system that facilitates reordering of content items, according to an embodiment of the present disclosure.

FIG. 19 illustrates a network diagram of an example system that can be utilized in various scenarios and/or environments, according to an embodiment of the present disclosure.

FIG. 20 illustrates an example of a computer system that can be utilized in various scenarios and/or environments, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Systems and Methods for Processing Orders of Content Items

Conventional techniques can store and display large numbers of photos. According to these techniques, photos may be uploaded and stored locally or remotely. These techniques are helpful to present photos to the persons who uploaded them and even to others who have been provided with shared access to the photos.

A large number of photos invites organization and reordering of the photos. Such reorganization and reordering can be performed according to user selected categories and topics for more user friendly and efficient access to the photos. Unfortunately, conventional techniques can be labor intensive (e.g., due to small screen sizes of mobile phones) and lack a streamlined capability to manage photos in this manner. As a result, related photos are often not optimally organized and ordered. When shared with others, their impact can be muted. Moreover, conventional techniques typically allow a user to select, upload, and publish photos to an online account, such as an account associated with a social networking service or a social media service. Unfortunately, once photos are chosen for uploading, the user is unable to reorder those photos until after the photos are actually published. Even systems that allow reordering of photos before publication may nonetheless limit the user's ability to effectively tell a story with the photos, particularly if the user is using a mobile phone or a tablet computing device.

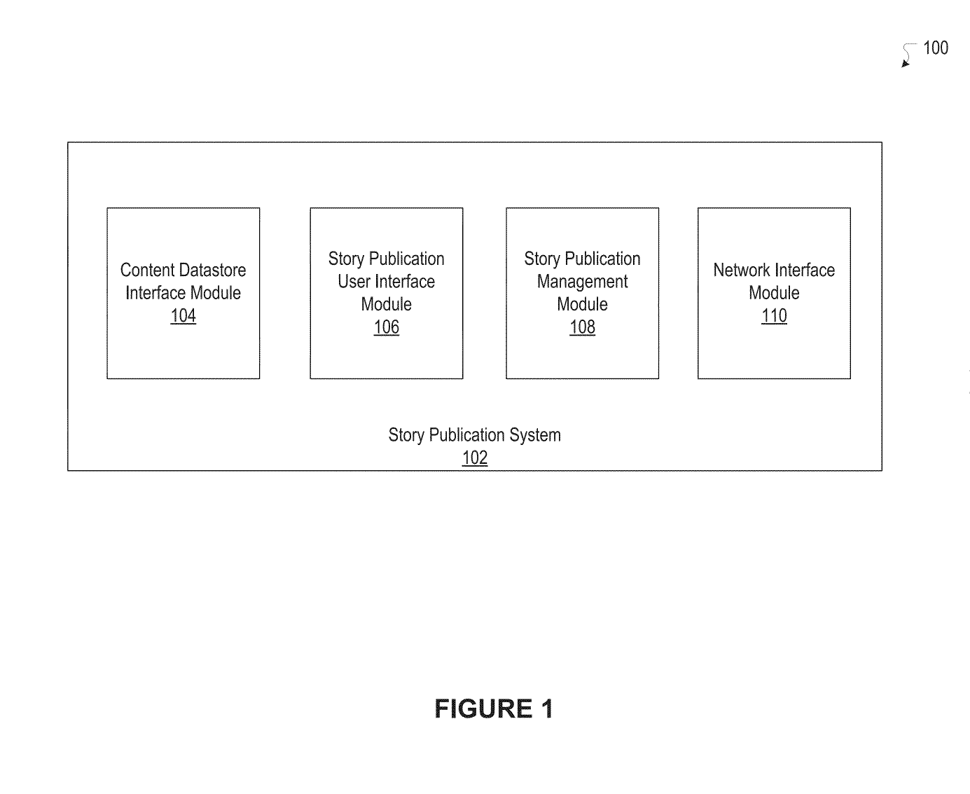

FIG. 1 illustrates an example environment 100 including a story publication system 102, according to an embodiment of the present disclosure. The story publication system 102 includes a content datastore interface module 104, a story publication user interface module 106, a story publication management module 108, and a network interface module 110. One or more of the content datastore interface module 104, the story publication user interface module 106, the story publication management module 108, and the network interface module 110 may be coupled to one another or to components external to the story publication system 102 and not explicitly shown therein. It is noted the components shown in this figure and all figures herein are exemplary only, and other implementations may include additional, fewer, or different components. Some components may not be shown so as not to obscure relevant details.

The story publication system 102 may create stories using content items captured on or otherwise accessible to a computing device. The stories may be shared with others, published in a feed associated with the user, stored locally on the computing device, or stored remotely on a server coupled to the computing device through a network connection. In some embodiments, the stories are published to the user or the user's account associated with a social networking service or a social media service. The content items in the stories may include any type of digital content, including but not limited to: digital images, digital audio, digital video, map data, hashtags, social tags (e.g., user tags, facial recognition tags, location tags, activity tags, etc.). The content items in the stories may also include metadata associated with digital content, including metadata added by the user as well as metadata added by other users (e.g., social networking friends, etc.). In an embodiment, the computing device comprises a device having a touchscreen display; the touchscreen display may include a touchscreen user interface. The computing device may also comprise any computing device having an input device, such as a mouse or a trackpad.

The content datastore interface module 104 may be coupled to a content item datastore. The content datastore interface module 104 may also be coupled to a camera or a scanner of the computing device. The content datastore interface module 104 may instruct the camera to initiate content item capture. The content datastore interface module 104 may also be coupled to a file system of the computing device. For example, the content datastore interface module 104 may interface with memory and/or storage (e.g., Flash memory, internal memory cards, external memory cards, etc.) of the computing device to access files stored thereon. Moreover, the content datastore interface module 104 may be coupled to a server that stores content items. For example, the content datastore interface module 104 may interface with cloud-based storage or other networked storage associated with the user. As another example, the content datastore interface module 104 may interface with any networked server that the user may access through the Internet.

The story publication user interface module 106 may provide a user interface that allows a user to create a story and to associate content items with the story. The user interface may also allow the user to reorder the content items before the story is published.

In some embodiments, the story publication user interface module 106 configures an application to display a story creation screen and a content reordering screen. The story creation screen may allow the user to identify a story and create annotations (e.g., title, captions, tags, etc.) for the story. The story creation screen may further allow the user to select content items for the story. The story creation screen may display the selected content items in a manner similar to how the file system of the computing device displays the selected content items. In the story creation screen content items may have a first order, which in some embodiments, corresponds to the order the content items were chosen for the story. When in the story creation screen, the story publication user interface module 106 may receive a modified selection gesture (such as a long press gesture, a right-click, or a double-click) that selects a reference content item for reordering.

In response to the modified selection gesture, the story publication user interface module 106 may display the content reordering screen. The content reordering screen may show the reference content item visually emphasized (e.g., silhouetted, shaded, darkened, etc.) and other content items listed or otherwise arranged in a manner optimized for the viewport of the computing device. For example, in the content reordering screen, the reference content item may be expanded and may have an outline around it, while other content items in the content reordering screen may be shrunk and listed in a vertical arrangement. Further, in the content reordering screen, the content items may be adapted in size to cover most of the viewport of the computing device. In an embodiment, the content items in the content reordering screen may be of a different size than the content items in the story creation screen. More specifically, the content items in the content reordering screen may be rendered smaller than the content items in the story creation screen. The content items in the content reordering screen may or may not keep their aspect ratios and other properties. For example, in an embodiment, content items depicting panoramas may keep their aspect ratios and may be sized with a width similar to other non-panorama content items.

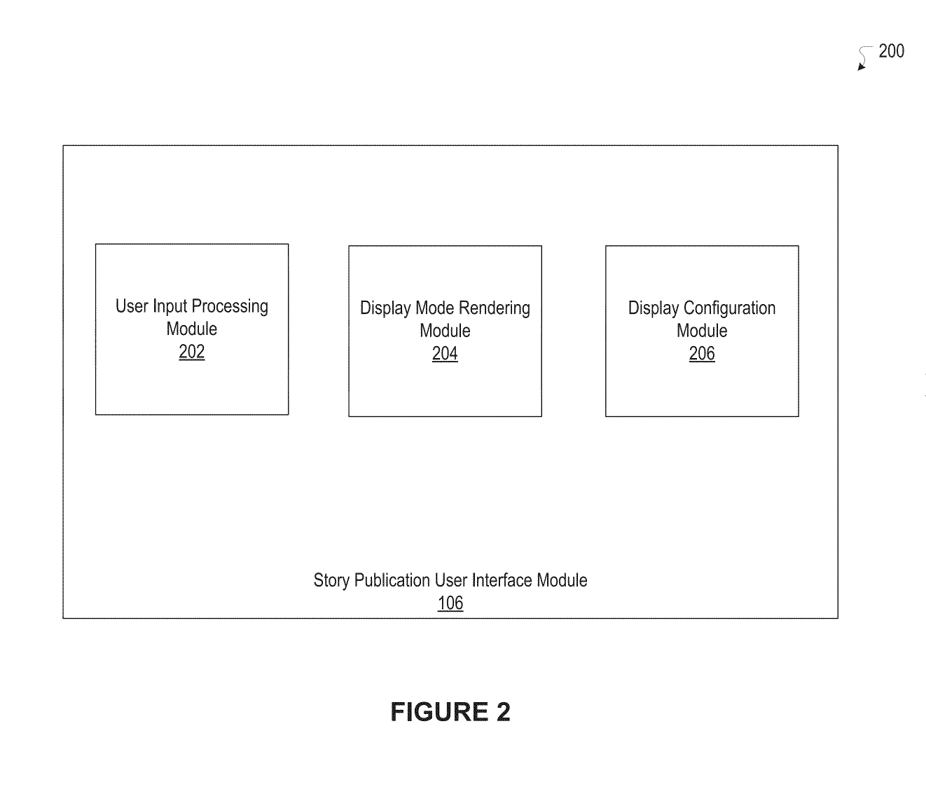

The content reordering screen may receive reordering gestures (e.g., horizontal slide gestures and/or vertical slide gestures) that allow the reference content item to be moved relative to the other content items. The other content items may move relative to the reference content item in order to accommodate a new position of the reference content item. The reordering gestures may cause scrolling of the content reordering screen. The story publication user interface module 106 may support multiple scroll speeds, as discussed further herein. The story publication user interface module 106 may return to a modified story creation screen that shows the content items reordered. The story publication user interface module 106 may also provide user interface elements that allow the story to be published. FIG. 2 shows the story publication user interface module 106 in greater detail.

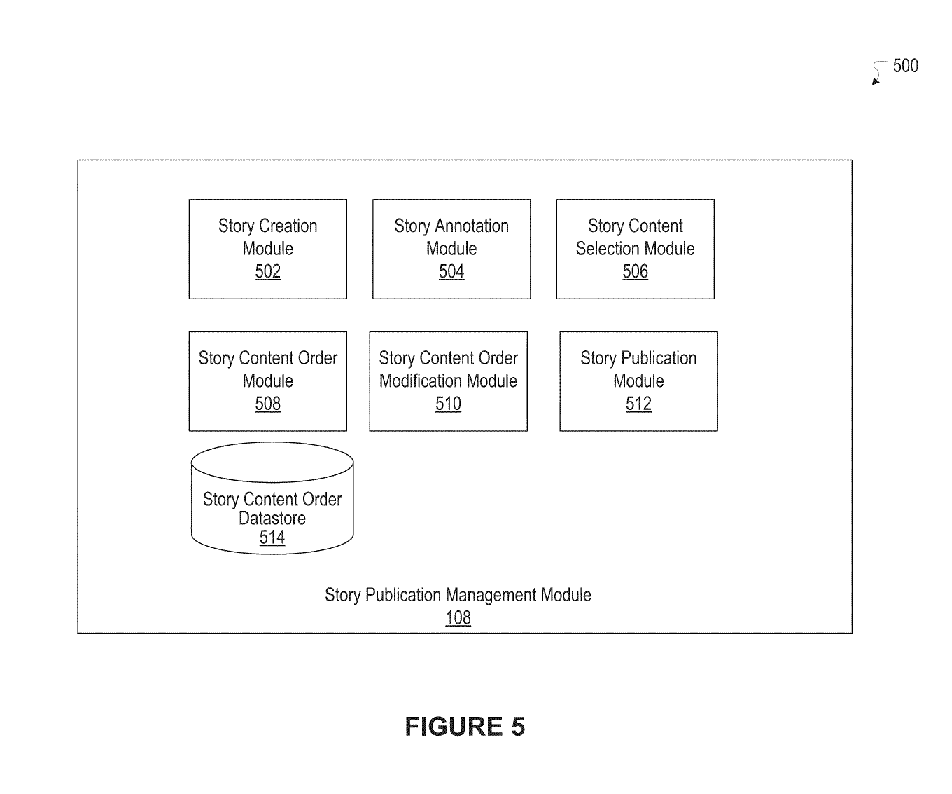

The story publication management module 108 may manage backend processes associated with story creation and selection of content items for stories. More specifically, the story publication management module 108 may also support the story publication user interface module 106 and may manage reordering processes used by the story publication user interface module 106. In some embodiments, the story publication management module 108 receives instructions to create a story and receives annotations for the story from the story publication user interface module 106. The story publication management module 108 may further receive instructions to select content items for the story. The story publication management module 108 may also receive instructions to reorder the content items based on instructions from the story publication user interface module 106. The story publication management module 108 may publish a story based on an instruction from the story publication user interface module 106. In an embodiment, the story publication management module 108 implements Application Programming Interfaces (APIs) or functional calls that publish a story to a social networking system or a social media system. FIG. 5 shows the story publication management module 108 in greater detail.

The network interface module 110 may couple the story publication system 102 to a computer network. In some embodiments, the network interface module 110 allows the content datastore interface module 104 to access remote content datastores. Further, the network interface module 110 may allow the story publication management module 108 to transfer content items and/or content items to other devices. The network interface module 110 may allow the story publication management module 108 to publish a story.

FIG. 2 illustrates an example environment 200 including the story publication user interface module 106, according to an embodiment of the present disclosure. The story publication user interface module 106 includes a user input processing module 202, a display mode rendering module 204, and a display configuration module 206. The user input processing module 202, the display mode rendering module 204, and the display configuration module 206 may be coupled to one another and/or components external to the story publication user interface module 106 and not explicitly shown therein. The user input processing module 202, the display mode rendering module 204, and the display configuration module 206 may be associated with a computing device having a display and a user input device, as discussed herein. In various embodiments, the display is a touchscreen display, such as touchscreen display incorporated into a mobile phone or a tablet computing device. Such a display may support the user input device by receiving gestures. In some embodiments, a user input device comprises a mouse or trackpad.

The user input processing module 202 may receive user input relating to stories and/or content items. The user input processing module 202 may be coupled to the display of the computing device. In embodiments in which the display comprises a touchscreen display, the user input processing module 202 may receive one or more gestures, including: gestures related to a location of a user's finger on the touchscreen display, gestures related to whether the user has tapped a specific area of the touchscreen display, gestures related to whether the user has held down (e.g., long pressed) a specific area of the touchscreen display, and gestures related to whether the user has provided horizontal or vertical movements (or movements having horizontal components or vertical components) on the touchscreen display. In embodiments in which the user input device comprises a mouse or a trackpad, the user input processing module 202 may receive information from the input device, including: the location of a cursor associated with the input device, whether the input device has selected an area of a display, whether the input device has right-clicked and/or double-clicked an area of the display, and whether the user has attempted to move items horizontally or vertically across the display.

As used herein, “vertical” and “horizontal” may refer to absolute, relative, or approximate directions. In some embodiments, “vertical” movements and gestures by a user may include substantially vertical or non-horizontal action by the user. In some embodiments, “vertical” may refer to a direction along a longitudinal or latitudinal axis of a display of a computing device receiving user input. Likewise, as used herein, in some embodiments, “horizontal” movements and gestures by the user may include substantially horizontal or non-vertical action by the user. In some embodiments, “horizontal” may refer to a direction along a longitudinal or latitudinal axis of a display of a computing device receiving user input. In some embodiments, a movement or gesture that is not precisely vertical or horizontal may be deconstructed to determine its vertical component and horizontal component.

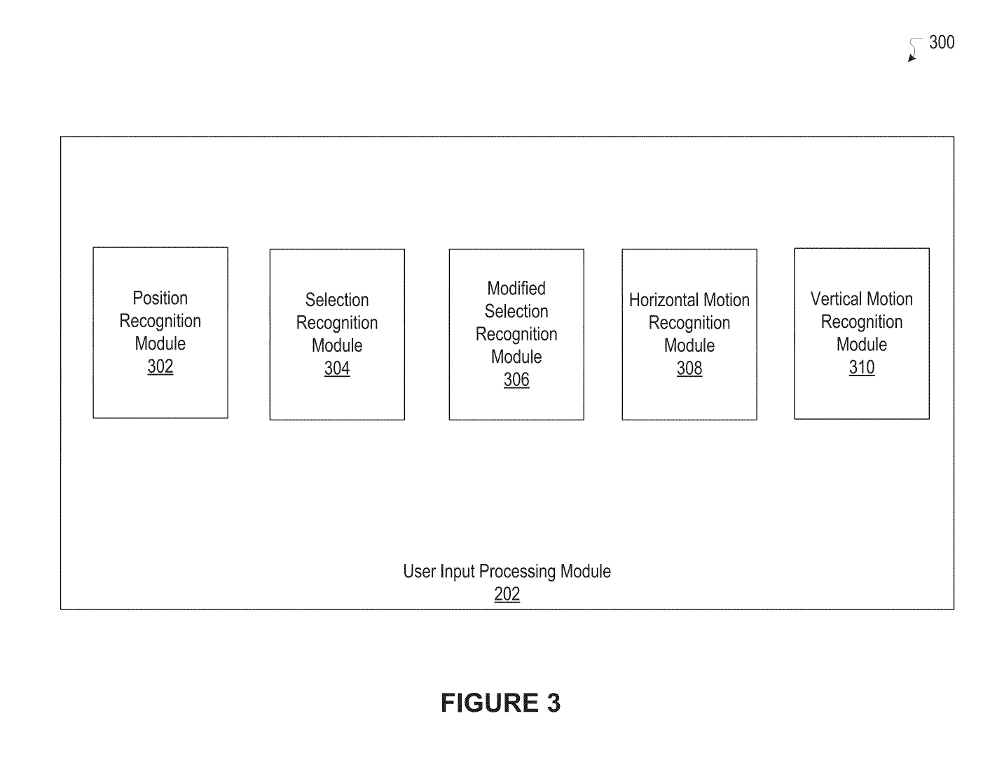

In some embodiments, the user input processing module 202 may process user input related to the creation of stories, annotations related to new stories, content items selected for stories, and publication of stories. The user input processing module 202 may also process user input related to reordering content items within a story, such as specific gestures and specific actions taken by a mouse or trackpad, relating to those content items. The user input processing module 202 may provide user input to the story publication management module 108. FIG. 3 shows the user input processing module 202 in greater detail.

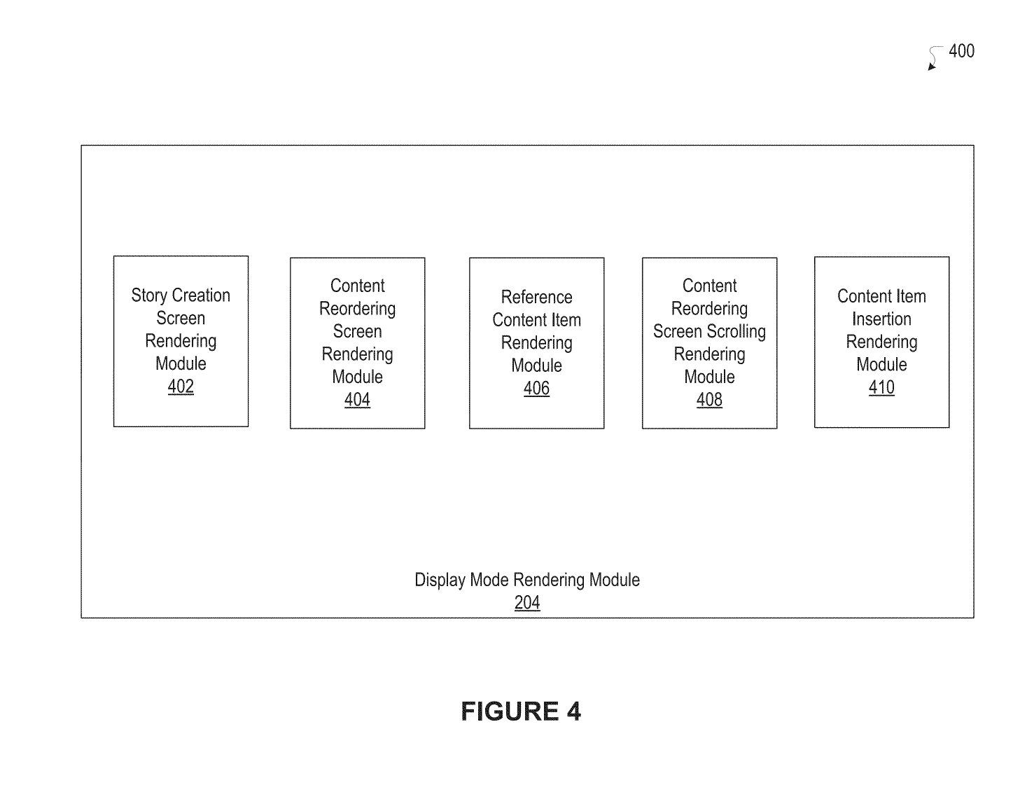

The display mode rendering module 204 may instruct the display configuration module 206 to show one of several display views. In some embodiments, the display mode rendering module 204 instructs the display configuration module 206 to show a story creation screen that allows a user to create a story, select content for the story, and ultimately publish the story. The display mode rendering module 204 may also instruct the display configuration module 206 to show a content reordering screen in which a user can reorder content items based on user input received by the user input processing module 202. The display mode rendering module 204 may base a determination to activate a particular display mode on information form the story publication management module 108. FIG. 4 shows the display mode rendering module 204 in further detail.

The display configuration module 206 may configure the display of the computing device to show information relevant to creating stories, selecting content items for stories, and publishing stories. The display configuration module 206 may be coupled to the display mode rendering module 204. The display configuration module 206 may configure the display to allow a user to: create a story; enter annotations for the story; select content items for the story; and reorder content items selected for the story. The display configuration module 206 may also display a story creation screen and/or a content reordering screen to facilitate story creation based on instructions from the display mode rendering module 204. The views and/or the orders of content items may be provided by the story publication management module 108.

FIG. 3 illustrates an example environment 300 including the user input processing module 202, according to an embodiment of the present disclosure. The user input processing module 202 includes a position recognition module 302, a selection recognition module 304, a modified selection recognition module 306, a horizontal motion recognition module 308, and a vertical motion recognition module 310. One or more of the position recognition module 302, the selection recognition module 304, the modified selection recognition module 306, the horizontal motion recognition module 308, and the vertical motion recognition module 310 may be coupled to one another and/or to components external to the user input processing module 202 and not explicitly shown therein.

The position recognition module 302 may recognize the position of a relevant area on a display. In a touchscreen embodiment, the position recognition module 302 recognizes an area of a touchscreen display the user is touching. In various embodiments, the position recognition module 302 recognizes the position of the cursor on the display associated with an input device.

The selection recognition module 304 may be configured to recognize a selection of a content item or of an area of the display. In a touchscreen embodiment, the selection recognition module 304 recognizes a tap gesture corresponding to an area on the display. For example, the selection recognition module 304 may recognize a user's tapping of a content item. In various embodiments, the selection recognition module 304 recognizes a mouse or trackpad click of a content item or other area of the display. In some embodiments, the selection recognition module 304 provides other modules, such as the story publication management module 108, with an identifier (e.g., a Universally Unique Identifier (UUID), a name, etc.) of a content item that has been selected.

The modified selection recognition module 306 may be configured to recognize a modified selection of a content item or other area of the display. In a touchscreen embodiment, the modified selection recognition module 306 recognizes a long press (e.g., a tap on the screen that exceeds a predetermined length of time) gesture corresponding to the user's tapping of an area on the display. In various embodiments, the modified selection recognition module 306 recognizes a double-click or a right-click from a mouse or trackpad related to an area of the display. In various embodiments, the modified selection recognition module 306 provides other modules, such as the story publication management module 108, with an identifier (e.g., a Universally Unique Identifier (UUID), a name, etc.) of a content item that is the subject of a modified selection.

The horizontal motion recognition module 308 may be configured to recognize horizontal motion taken with respect to a content item or other area of the display. In a touchscreen embodiment, the horizontal motion recognition module 308 recognizes when a content item or other area of the display is being moved left or right. The horizontal motion recognition module 308 may also recognize horizontal swipes. In various embodiments, the horizontal motion recognition module 308 may recognize when a content item or other area of the display is being dragged right or left pursuant to instructions from a mouse or a trackpad.

The vertical motion recognition module 310 may be configured to recognize vertical motion taken with respect to a content item or other area of the display. In a touchscreen embodiment, the vertical motion recognition module 310 recognizes when a content item or other area of the display is being moved up or down. The vertical motion recognition module 310 may also recognize vertical swipes.

In various embodiments, the vertical motion recognition module 310 may recognize when a content item or other area of the display is being dragged up or down pursuant to instructions from a mouse or a trackpad.

FIG. 4 illustrates an example environment 400 including the display mode rendering module 204, according to an embodiment of the present disclosure. The display mode rendering module 204 may include a story creation screen rendering module 402, a content reordering screen rendering module 404, a reference content item rendering module 406, a content reordering screen scrolling module 408, and a content item insertion rendering module 410. One or more of the story creation screen rendering module 402, the content reordering screen rendering module 404, the reference content item rendering module 406, the content reordering screen scrolling module 408, and the content item insertion rendering module 410 may be coupled to one another and/or to components external to the display mode rendering module 204 and not explicitly shown therein.

The story creation screen rendering module 402 may instruct the display to render a story creation screen. The story creation screen may allow a user to create a story, add annotations to the story, add content items to the story, and publish the story. In some embodiments, the story creation screen rendered by the story creation screen rendering module 402 may receive user input. For example, the story creation screen may include portions that can recognize positions of relevant areas, selections of content items or relevant areas, and modified selections of content items or relevant areas. In an embodiment, the story creation screen may correspond to a screen of a social networking application that asks users to create a story with content items.

The content reordering screen rendering module 404 may instruct the display to render a content reordering screen. The content reordering screen may display content items that were selected for a story in a format that is optimized for viewing on the display. For instance, in embodiments where the display comprises a touchscreen display of a mobile phone or a tablet computing device, the content reordering screen displays content items in a vertical format that allows a user to preview a plurality of content items. The content items may cover a substantial area of the viewport of the display (e.g., they may cover ninety percent of the display), and may each be separated by a fixed distance or a fixed number of pixels. The content reordering screen rendering module 404 may receive user input (e.g., touch positions, selections, modified selections, horizontal motions, vertical motions, etc.) with respect to the content items.

The reference content item rendering module 406 may instruct the display to render a reference content item in the content reordering screen. In various embodiments, the reference content item rendering module 406 instructs the display to visually emphasize the reference content item by providing a line around the reference content item and highlighting the interior portions of the reference content item. In some embodiments, the reference content item rendering module 406 increases the size of the reference content item relative to the other content items in the content reordering screen. In some embodiments, the reference content item rendering module 406 instructs the display to render the reference content item to the side of other content items so that it appears the order of the reference content item is being changed relative to the other content items in the content reordering screen. In some embodiments, the reference content item rendering module 406 may receive user input with respect to the reference content item. For example, the reference content item rendering module 406 may receive horizontal and/or vertical motions with respect to the reference content item.

The content reordering screen scrolling module 408 may render scrolling of the content reordering screen. More specifically, the content reordering screen scrolling module 408 may make the content items in the content reordering screen appear as if they are scrolling at one or more speeds. In some embodiments, the scrolling may be vertical scrolling. For example, the content items in the content reordering screen may appear to be moving up or down in the opposite direction to the direction a reference content item is being moved. In various embodiments, the content reordering screen scrolling module 408 supports a plurality of scrolling speeds.

In some embodiments, the scroll speed may be dynamic and determined based on the distance between the initial position of a reference content item and the location of the cursor or touchpoint at a particular instant in time during a gesture. For example, the content reordering screen scrolling module 408 may support a scroll speed of zero at which the content items do not scroll when, upon selection of the reference content item, the cursor or touchpoint is within a threshold distance of the initial position of the reference content item. The content reordering screen scrolling module 408 may also cause content items to be scrolled at other speeds based on (e.g., proportional to) the distance between the position of a user's finger/cursor and the initial position of the reference content item in the content reordering screen as the finger/cursor moves. The content reordering screen scrolling module 408 may further support a maximum scroll speed at which content items are scrolled when the distance between the position of a user's finger/cursor and the position of the reference content item satisfies a threshold distance between the initial position of the reference content item and the location of the cursor or touchpoint at a particular instant in time during the gesture. The content reordering screen scrolling module 408 may receive user input, such as vertical motions, in various embodiments.

The content item insertion rendering module 410 may render insertion of content items into the content reordering screen. In various embodiments, the content item insertion rendering module 410 inserts the reference content item into a specified location in the list of content items in the content reordering screen. The content item insertion rendering module 410 may further part content items at an insertion location, and may render the reference content item at or into the insertion location. The content item insertion rendering module 410 may receive user input, such as horizontal motions, in various embodiments.

FIG. 5 illustrates an example environment 500 including the story publication management module 108, according to an embodiment of the present disclosure. The story publication management module 108 includes a story creation module 502, a story annotation module 504, a story content selection module 506, a story content order module 508, a story content order modification module 510, a story publication module 512, and a story content order datastore 514. The story creation module 502, the story annotation module 504, the story content selection module 506, the story content order module 508, the story content order modification module 510, the story publication module 512, and the story content order datastore 514 may be coupled to one another and/or components external to the story publication management module 108 and not explicitly shown therein.

The story creation module 502 may facilitate the creation of stories. More specifically, the story creation module 502 may configure a story creation screen to request a user to create a new story and may create backend processes related to necessary pages, scripts etc. that would help publish the new story. The story creation module 502 may receive information about the new story from the story publication user interface module 106. In some embodiments, the story creation module 502 may notify a social networking service or a social media service that a new story is being created. The story creation module 502 may request the social networking service or the social media service to update permissions and/or other information related to the user creating the story accordingly. The story creation module 502 may provide information about a new story being created to the story publication user interface module 106 so that the story publication user interface module 106 can request other information from a user, such as annotations for the story, as discussed further herein.

The story annotation module 504 may facilitate the annotation of stories. The story annotation module 504 may configure a story creation screen to accept a title, captions, tags, and other annotations for a story being created. The story annotation module 504 may also update backend processes related to the story to reflect the annotations. The story annotation module 504 may receive the annotations from the story publication user interface module 106. In some embodiments, the story annotation module 504 notifies the social networking service and/or social media service publishing the story of the annotations being added to the story. The story annotation module 504 may provide the annotations to the story publication user interface module 106, so that the story publication user interface module 106 can request other information from the user, such as content items for the story, as discussed further herein.

The story content selection module 506 may facilitate selection of content items for a story. The story content selection module 506 may configure a story creation screen to associate content items with a story being created. In some embodiments, the story content selection module 506 may interface with one or more of a camera, a file system, memory and/or storage, and cloud-based storage of a computing system to facilitate identification of content items relevant to a story. In some embodiments, the story content selection module 506 configures the story publication user interface module 106 to display content items that can be selected for the story. In some embodiments, the story content selection module 506 instructs the story publication user interface module 106 to accept selection of individual content items. In various embodiments, the story content selection module 506 instructs the story publication user interface module 106 to provide a batch uploader that allows selection of a plurality of content items for the story. The story content selection module 506 may provide the identities of selected content items to the story content order module 508.

The story content order module 508 may order the content items selected for a story. More specifically, the story content order module 508 may assign a rank for each content item selected for a story. The rank may comprise a number or other value that facilitates ordering of the content items for the story. In an embodiment, the story content order module 508 may store and/or manage the ranks of the content items in the story content order datastore 514. For example, the story content order module 508 may store and/or manage a database in the story content order datastore 514 that has, as its first column, the names of content items, and as its second column, the ranks of content items. In various embodiments, the story content order module 508 may implement multiple orders of content items. For instance, the story content order module 508 may implement a first order and a second order of content items. In the first order of content items, the rank of each content item may correspond to the order specific content items were selected for a story. In the second order of content items, content may be ordered according to modifications by a user. The modifications may be based on instructions from the story content order modification module 510.

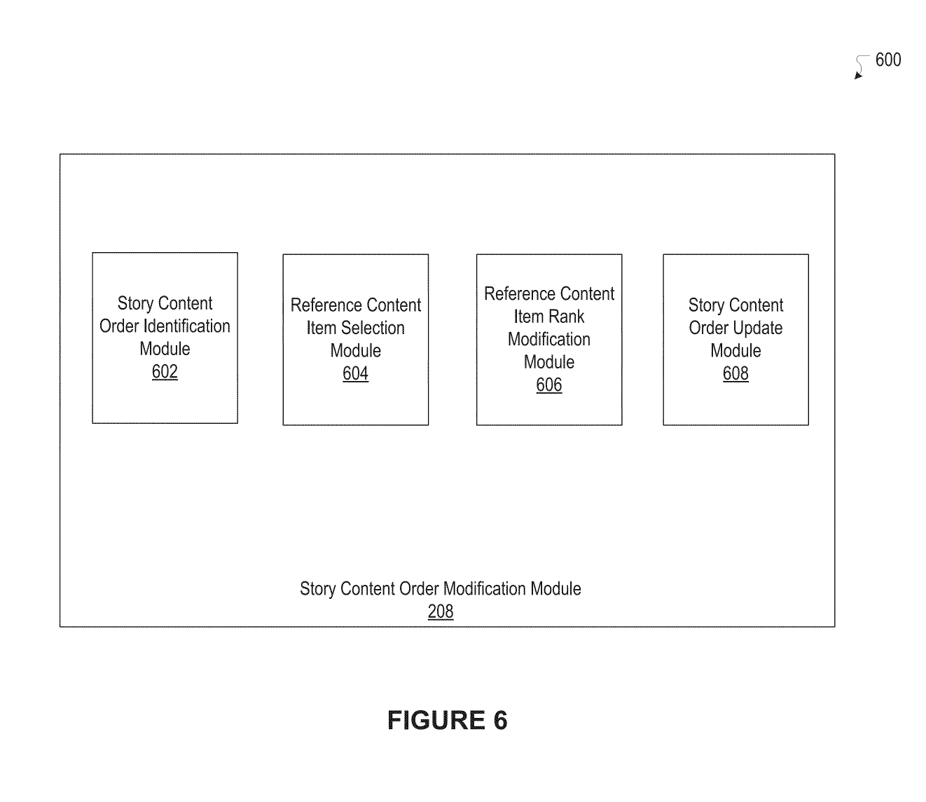

The story content order modification module 510 may facilitate modifying the order of content items for a story. The story content order modification module 510 may receive instructions to reorder a content item from the story publication user interface module 106. More specifically, the story content order modification module 510 may receive a selection from the story publication user interface module 106 of a reference content item. The story content order modification module 510 may also identify whether the story publication user interface module 106 has instructed the rank of the reference content item to change. The story content order modification module 510 may correspondingly change the rank of the reference content item and other content items selected for the story in the story content order datastore 514. The story content order modification module 510 may support a content reordering screen to reorder the reference content item in relation to the other selected content item, as discussed herein. In some embodiments, the story content order modification module 510 implements an iterative process that reorders content items more than once before a story is published. FIG. 6 shows the story content order modification module 510 in greater detail.

The story publication module 512 may facilitate publication of a story. More specifically, the story publication module 512 may provide instructions to a social networking service or a social media service to publish a story. In an embodiment, the story publication module 512 interfaces with APIs and/or functions of the social networking service or social media service that facilitate publication of the content items. Further, the story publication module 512 may publish the story to a feed associated with the user who created the story. In an embodiment, the story to be published has content items that have been reordered by the story content order modification module 510. The story publication module 512 may receive instructions to publish the story from the story publication user interface module 106.

The story content order datastore 514 may store content items and their specific ranks with respect to the order of content items in a story. The story content order datastore 514 may receive content items and their ranks from the story content order module 508 and the story content order modification module 510.

FIG. 6 illustrates an example environment 600 including the story content order modification module 510, according to an embodiment of the present disclosure. The story content order modification module 510 may include a story content order identification module 602, a reference content item selection module 604, a reference content item rank modification module 606, and a story content order update module 608. One or more of the story content order identification module 602, the reference content item selection module 604, the reference content item rank modification module 606, and the story content order update module 608 may be coupled to one another and/or components external to the story content order modification module 510 and not shown explicitly therein.

The story content order identification module 602 may identify the order of content items in a story. More specifically, the story content order identification module 602 may identify the ranks and/or orders of each content item chosen for a story. The story content order identification module 602 may obtain the orders of content items based on the ranks assigned to content items by the story content order module 508. In some embodiments, the story order identification module obtains a first order of content items corresponding to the orders the content items were selected for a story. The story content order identification module 602 may also obtain updated orders of content items from the story content order update module 608. The story content order identification module 602 may provide the order of content items when so requested.

The reference content item selection module 604 may receive a selection of a reference content item that is to be re-ranked. In an embodiment, the reference content item selection module 604 may receive from the story publication user interface module 106 a selection of a reference content item. The selection may identify the reference content item by Universally Unique Identifier (UUID), by name, or by the original ranking of the reference content item. The reference content item selection module 604 may provide the identifier of the reference content item to the reference content item rank modification module 606.

The reference content item rank modification module 606 may modify the rank of the reference content item. More specifically, the reference content item rank modification module 606 may facilitate changing the rank of the reference content item and the ranks of other content items in the order. In an embodiment, the reference content item rank modification module 606 receives the instructions to modify the rank from the story publication user interface module 106. More specifically, as discussed herein, the reference content item rank modification module 606 may receive instructions from the story publication user interface module 106 that a user of the computing device moved the reference content item horizontally out of order from the other content items in the story. The reference content item rank modification module 606 may also receive instructions from the story publication user interface module 106 that a user of the computing device moved the reference content item vertically to a new rank in the order of content items in the story. The reference content item rank modification module 606 may further receive instructions from the story publication user interface module 106 that a user of the computing device reinserted the reference content item into the order of content items in the story, thereby reordering the reference content item with respect to the order of the content items selected for the story. The reference content item rank modification module 606 may provide the new rank of the reference content item as well as the new rank of the content items impacted by the reordering of the reference content item to the story content order update module 608.

The story content order update module 608 may update the order of content items in the story based on the modified rank of the reference content item. In some embodiments, the story content order update module 608 assigns new ranks to all content items in the story having a higher rank than the modified rank of the reference content item. The story content order update module 608 may provide the new ranks of the content items in the story to other modules, such as other modules of the story publication management module 108. In some embodiments, a story may be published with the content items reordered according to the updated orders.

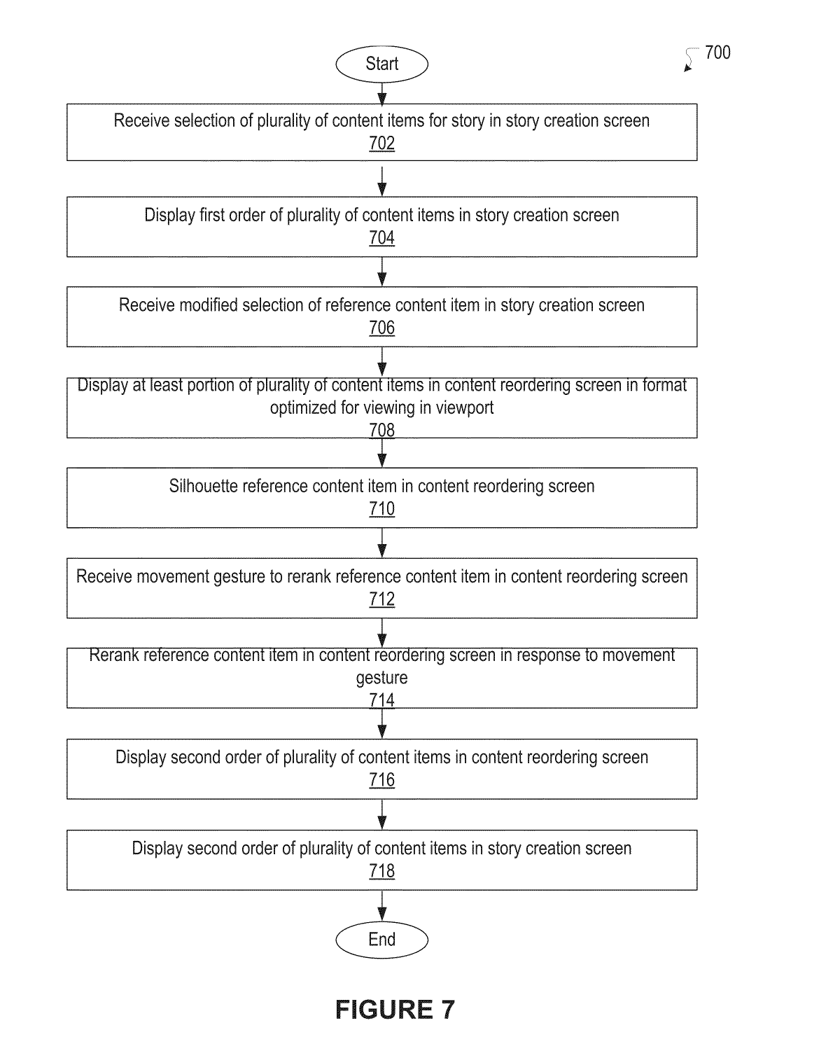

FIG. 7 illustrates an example method 700 for reordering content items in a story with a user interface, according to an embodiment of the present disclosure. It should be appreciated that there can be additional, fewer, or alternative steps performed in similar or alternative orders, or in parallel, within the scope of the various embodiments unless otherwise stated.

The example method 700 can receive a selection of a plurality of content items for a story in a story creation screen at block 702. The content items may include, in various items, any items of digital content, such as digital images, digital audio, digital video, map data, hashtags, and social tags (e.g., user tags, facial recognition tags, location tags, and activity tags).

The example method 700 can display a first order of the plurality of content items in a story creation screen at block 704. The first order of the plurality of content items can correspond to the order in which content items were chosen for upload. The first order of the plurality of content items can also correspond to any other known or convenient order, such as an order of the content items by size, or by alphabetical or reverse alphabetical order based on annotations associated with the content items.

The example method 700 can receive a selection of a reference content item in the story creation screen at block 706. In some embodiments, a modified selection gesture selecting a reference content item is received. The modified selection gesture may include a long-press gesture, or a right-click or double-click, of a reference content item. The reference content item may be a content item the user is attempting to rerank.

The example method 700 can display at least a portion of the plurality of content items in a content reordering screen in a format optimized for viewing in a viewport of the computing device at block 708. In an embodiment, at least some of the plurality of content items may be shown in a content reordering screen. The shown content items may be displayed vertically so that viewing of multiple content items is optimized in the display of a mobile phone or a tablet computing device.

The example method 700 can visually emphasize the reference content item in the content reordering screen at block 710. For example, the reference content item may be expanded and may have an outline around it, while other content items in the content reordering screen may be shrunk and listed in a vertical arrangement. The reordering screen may further be configured to receive gestures relating to the reference content item.

The example method 700 can receive a movement gesture to rerank the reference content item in the content reordering screen at block 712. In some embodiments, a horizontal motion (e.g., horizontal swipe) of the reference content item is received. Further, a vertical motion (e.g., a vertical swipe) of the reference content item may be received. The reference content item may be dragged and inserted at a selected position into the list of content items. In various embodiments, the reference content item is dragged in an arbitrary direction in the content reordering screen.

The example method 700 can rerank the reference content item in the content reordering screen in response to the movement gesture at block 714. More specifically, the reference content item may be removed and reinserted into the list of content items at a location the user desires. The content items may be reranked according to where the reference content item was inserted into the list of content items.

The example method 700 can display a second order of the plurality of content items in the content reordering screen at block 716. More specifically, the plurality of content items may be displayed according to the second order after the reference content item was reinserted into the plurality of content items.

The example method 700 can display the second order of the plurality of content items in the story creation screen at block 718. For example, the story creation screen may display the content items based on the second order.

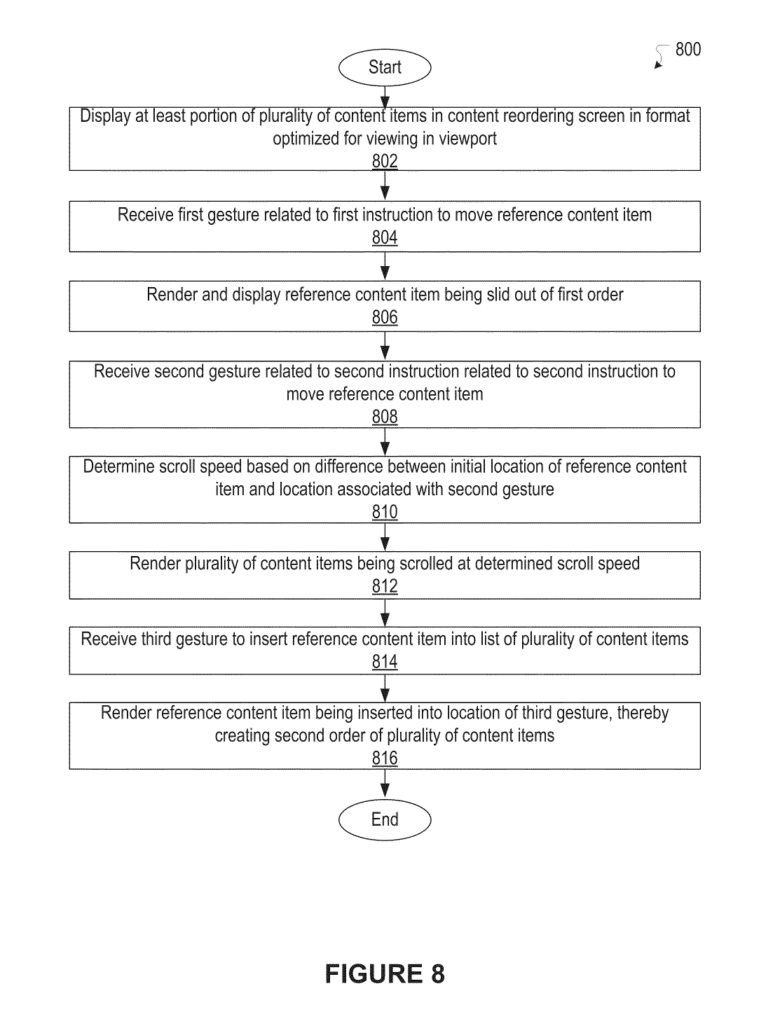

FIG. 8 illustrates an example method 800 for reordering content items in a story with a user interface, according to an embodiment of the present disclosure. Again, it should be appreciated that there can be additional, fewer, or alternative steps performed in similar or alternative orders, or in parallel, within the scope of the various embodiments unless otherwise stated.

The example method 800 can display at least a portion of a plurality of content items in a content reordering screen in a format optimized for viewing on a viewport of a computing device at block 802. In an embodiment, at least some of the plurality of content items may be shown in the content reordering screen. The shown content items may be displayed vertically so that viewing of multiple content items is optimized in the display of a mobile phone or a tablet computing device.

The example method 800 can receive a first gesture related to a first instruction to move a reference content item at block 804. In some embodiments, a horizontal motion (or substantially horizontal motion or non-vertical motion) relating to the reference content item may be received in the content reordering screen. More specifically, a horizontal swipe gesture or a horizontal drag instruction may be received. In a specific embodiment, the first gesture may require a minimum amount of horizontal motion before reordering is facilitated. More specifically, the first gesture need not be based purely on where a cursor or touchpoint is relative to a vertical axis of the content reordering screen. As a result, reordering need not be triggered simply by a modified selection of a content item at the extremes of the content reordering screen. The resulting embodiments may ensure content reordering processes that are less sensitive and less prone to user error.

The example method 800 can render and display the reference content item being slid out of order at block 806. More specifically, the content reordering screen may show the reference content item being slid horizontally away from the rest of the plurality of content items. A gap may be created in the space the reference content item previously resided. The gap may further be closed by relative movement of the content item immediately preceding the reference content item (and adjacent content items) and relative movement of the content item immediately following the reference content item (and adjacent content items) toward one another.

The example method 800 can receive a second gesture related to a second instruction to move the reference content item at block 808. In an embodiment, a vertical motion (or substantially vertical motion or non-horizontal motion) relating to the reference content may be received in the content reordering screen. More specifically, a vertical swipe gesture or a vertical drag may be received as the second gesture.

The example method 800 can determine a scroll speed based on the difference of an initial location of the reference content item and a location associated with the second gesture at block 810. The scroll speed may be dynamic and determined based on the distance between the initial location of the reference content item and the location of the cursor or touchpoint at a particular instant in time during the second gesture. For example, if the location of the cursor or touchpoint at a particular time during the second gesture is near or within a first threshold distance of the reference content item, the scroll speed may be zero (i.e., the content reordering screen may not scroll at all). As the location of the cursor or touchpoint at a later second time during the second gesture is moved away from the initial location of the reference content item beyond the first threshold distance, the scroll speed may be increased from an earlier scroll speed. If the location of the cursor or touchpoint at a later third time during the second gesture is moved toward the initial location of the reference content item, the scroll speed may be decreased from an earlier value. When the location of the cursor or touchpoint at any time during the second gesture satisfies a second threshold distance from the initial location of the reference, the scroll speed may reach a maximum value.

The determination of scroll speeds can be based on various techniques. In some embodiments, the scroll speed may be proportional or otherwise correlate with the distance between the initial location of the reference content item and the location of the cursor or touchpoint at a particular instant in time during the second gesture. In some embodiments, the scroll speed may be calculated depending on the distance of the touchpoint from the edges of the screen and/or the number of content items. In some embodiments, the scroll speed may change continuously. In other embodiments, the scroll speed may change non-continuously in discrete steps. For example, if the distance between the initial location of the reference content item and the location of the cursor or touchpoint at a particular instant in time is within a first selected range of distances, then the scroll speed may be set to a first constant scroll speed. Further to this example, if the distance between the initial location of the reference content item and the location of the cursor or touchpoint at a particular instant in time is within a second range of distances, then the scroll speed may be set to a second constant scroll speed, and so on.

The example method 800 can render the plurality of content items being scrolled at the determined scroll speed at block 812. More specifically, the content reordering screen can be scrolled at the scroll speed determined.

The example method 800 can receive a third gesture to insert the reference content item into the list of the plurality of content item at block 814. The third gesture may comprise a horizontal motion, such as a motion to insert the reference content item into the list of the plurality of content items. Examples of such motion include a horizontal swipe gesture and a horizontal drag of the reference content item.

The example method 800 can render the reference content item being inserted into a location associated with the third gesture, thereby creating a second order of the plurality of content items at block 816. The content reordering screen may allow the reference content item to be inserted at a location corresponding to the third gesture. This may have the effect of reordering the list of the plurality of content items.

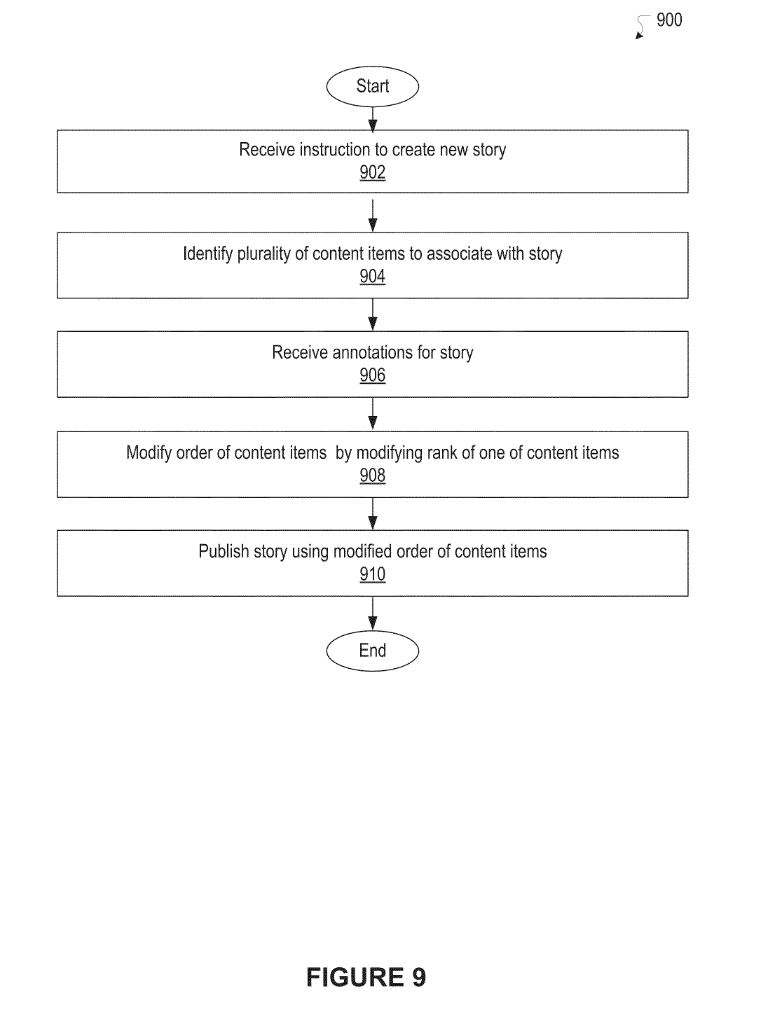

FIG. 9 illustrates an example method 900 for reordering content items in a story, according to an embodiment of the present disclosure. Again, it should be appreciated that there can be additional, fewer, or alternative steps performed in similar or alternative orders, or in parallel, within the scope of the various embodiments unless otherwise stated.

The example method 900 can receive an instruction to create a new story at block 902. More specifically, an instruction to create a new story may be received from a story creation screen.

The example method 900 can identify a plurality of content items to associate with the story at block 904. A plurality of content items may be selected from content items from the camera, the file system, or servers coupled to the computing device. The selection of the plurality of content items may be received from the story creation screen.

The example method 900 can receive annotations for the story at block 906. Annotations, such as a title, captions, tags, and other information may be received for a story from the story creation screen.

The example method 900 can modify the order of content items by modifying the rank of one of the content items at block 908. More specifically, a content reordering screen may be provided. In the content reordering screen, instructions to modify the order of the content items may be received. The instructions may be based, at least in part, on changing the rank of a reference content item. The order of the content items may therefore be modified to have a second order of content items.

The example method 900 can publish the story using the modified order of content items at block 910. More specifically, the story may be published with the modified order of content items to a variety of locations. In various embodiments, the story may be shared with others, published in a feed associated with the user, stored locally on the computing device, or stored remotely on a server coupled to the computing device through a network connection. The story may be published to a social networking service or a social media service.

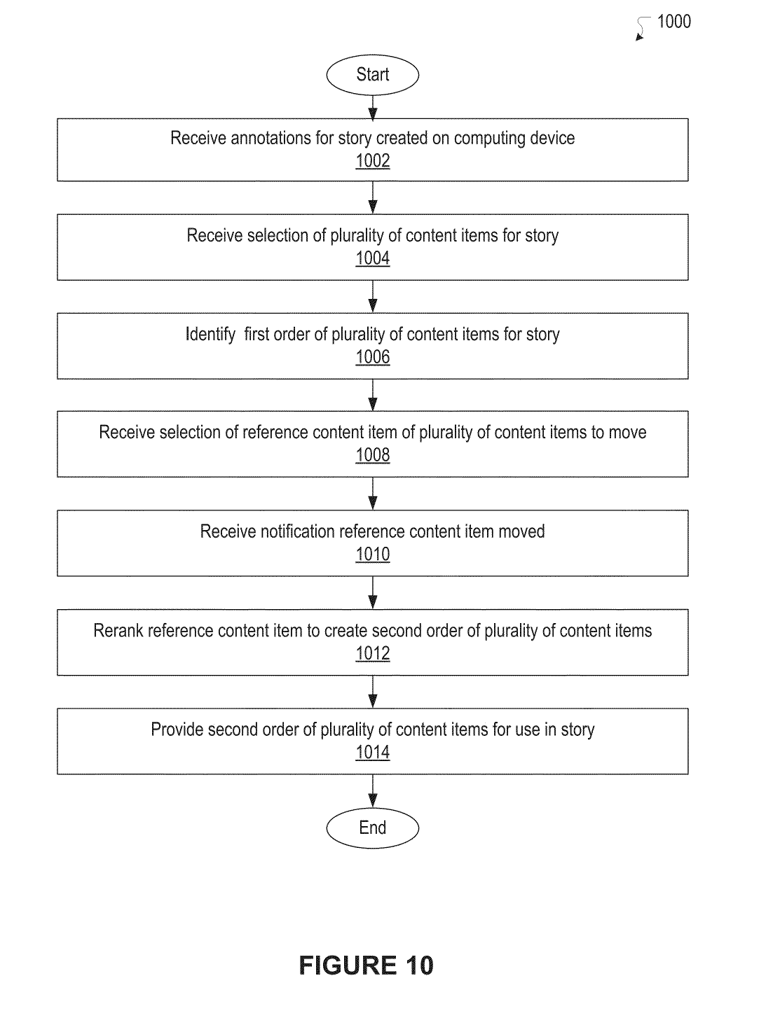

FIG. 10 illustrates an example method 1000 for reordering content items in a story, according to an embodiment of the present disclosure. Again, it should be appreciated that there can be additional, fewer, or alternative steps performed in similar or alternative orders, or in parallel, within the scope of the various embodiments unless otherwise stated.

The example method 1000 can receive annotations for a story created on a computing device at block 1002. In an embodiment, annotations such as a title, captions, tags, and other information may be received for a story. These annotations may be received from a story creation screen.

The example method 1000 can receive a selection of a plurality of content items for the story at block 1004. A plurality of content items may be selected from content items from the camera, the file system, or servers coupled to the computing device. The selection of the plurality of content items may be received from the story creation screen.

The example method 1000 can identify a first order of the plurality of content items for the story at block 1006. More specifically, a rank may be assigned to each content item to produce the first order. The first order of the plurality of content items can correspond to the order in which content items were chosen for upload. The first order of the plurality of content items can also correspond to any other known or convenient order, such as an order of the content items by size, or by alphabetical or reverse alphabetical order of annotations associated with the content items.

The example method 1000 can receive a selection of a reference content item of the plurality of content items for moving at block 1008. More specifically, a user interface module may provide a notification that a reference content item has been selected.

The example method 1000 can receive a notification that the reference content item was moved at block 1010. More specifically, a notification that the reference content item was reordered in the content reordering screen may be received.

The example method 1000 can rerank the reference content item to create a second order of the plurality of content items at block 1012. In an embodiment, the rank of the reference content item may be adjusted. The ranks of other content items may also be adjusted to create a second order of the plurality of content items.

The example method 1000 can provide the second order of the plurality of content items for use in the story at block 1014. For example, the second order of content items may be provided to the story creation screen so that the story can be modified and/or published.

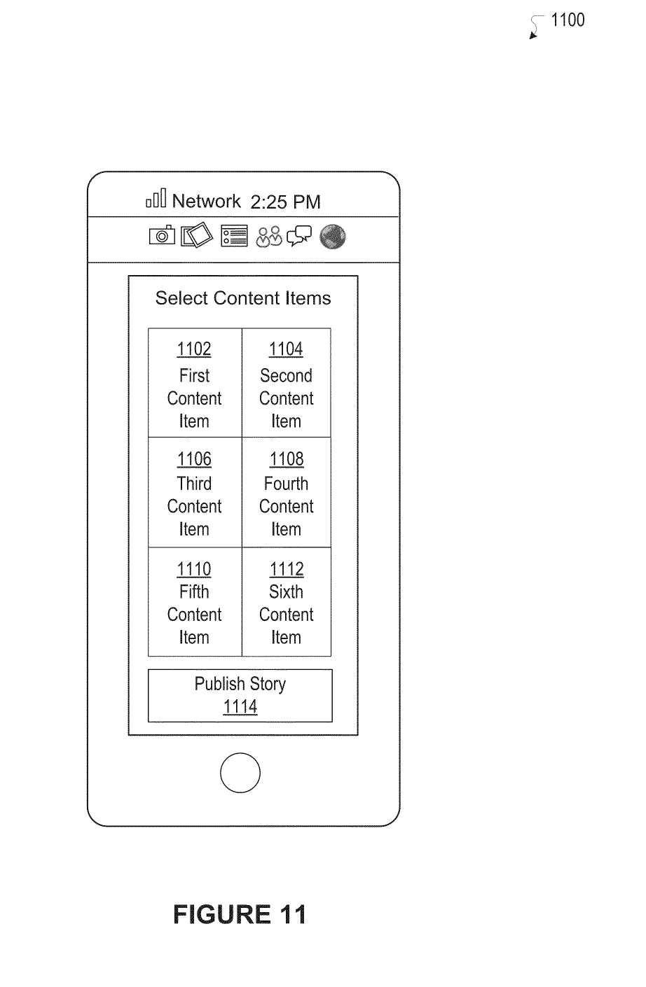

FIG. 11 illustrates an example screen 1100 of a user interface of a system that facilitates reordering of content items, according to an embodiment of the present disclosure. The screen 1110 may form a part of a story creation screen, as discussed herein. The screen 1100 may include a first content item 1102, a second content item 1104, a third content item 1106, a fourth content item 1108, a fifth content item 1110, and a sixth content item 1112. The screen 1100 may further include a story publication button 1114. In this example, the content items 1102-1112 have already been chosen for publication as a story. Though the screen 1100 contains two columns, it is noted that the screen may include a single column, or more than two columns in various embodiments. In an embodiment, the screen 1100 contains a single column with content items appearing larger than they would in a content reordering screen.

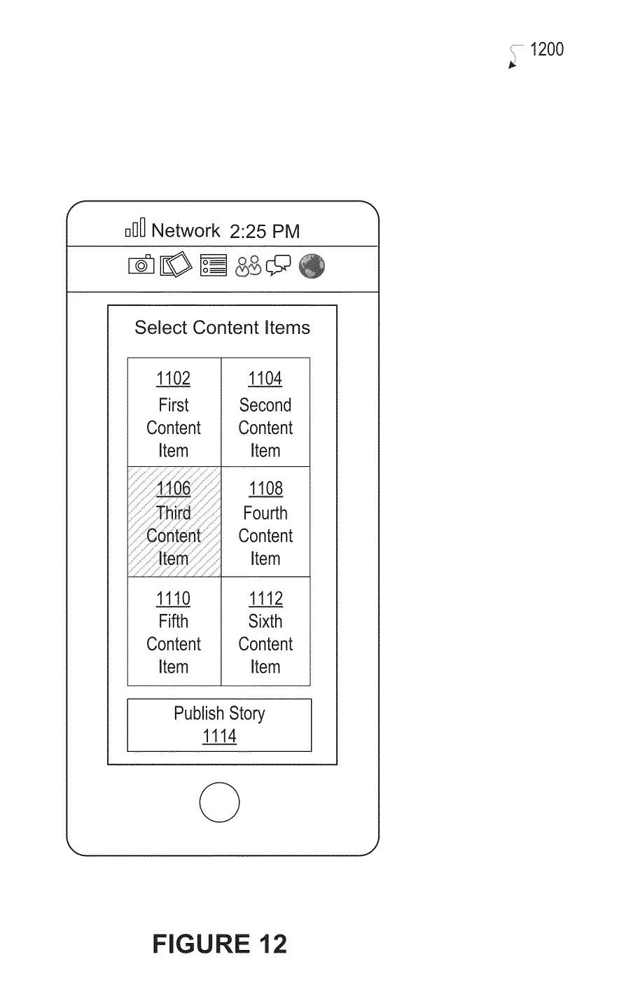

FIG. 12 illustrates an example screen 1200 of a user interface of a system that facilitates reordering of content items, according to an embodiment of the present disclosure. In the screen 1200, the third content item 1106 has received a modified selection. For example, a user may have long-pressed the third content item 1106 or double-clicked/right-clicked the third-content item 1106. The third content item 1106 may have been highlighted in the screen 1200 in response to the modified selection.

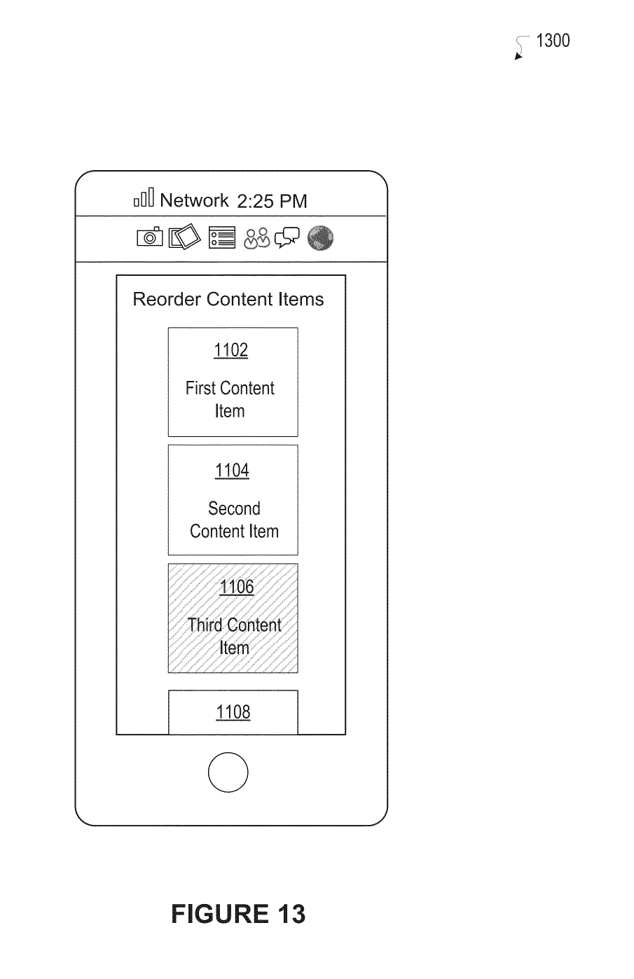

FIG. 13 illustrates an example screen 1300 of a user interface of a system that facilitates reordering of content items, according to an embodiment of the present disclosure. The screen 1300 may form part of a content reordering screen, as discussed herein. The screen 1300 may include the first content item 1102, the second content item 1104, the third content item 1106, and the fourth content item 1108. In some embodiments, the content reordering screen may selectively display a portion of the content items of the story creation screen. The selective display of a portion of the content items may be based on threshold proximity of the contents items to the selected (reference) content item based on distance or ranking in view of the available display space of the content reordering screen. As shown, the fifth content item 1110 and the sixth content item 1112 are not shown in the screen 1300. The first content item 1102 second content item 1104, third content item 1106, and fourth content item 1108, are shown in a vertical arrangement that is optimized for display in the viewport of the computing device. In this example, the first content item 1102, second content item 1104, third content item 1106, and fourth content item 1108 are sized so that their widths take up approximately 90 percent of the width of the viewport of the screen 1300. Other techniques to resize the content items to other dimensions are possible. The third content item 1106 may be highlighted due to the modified selection of the third content item 1106.

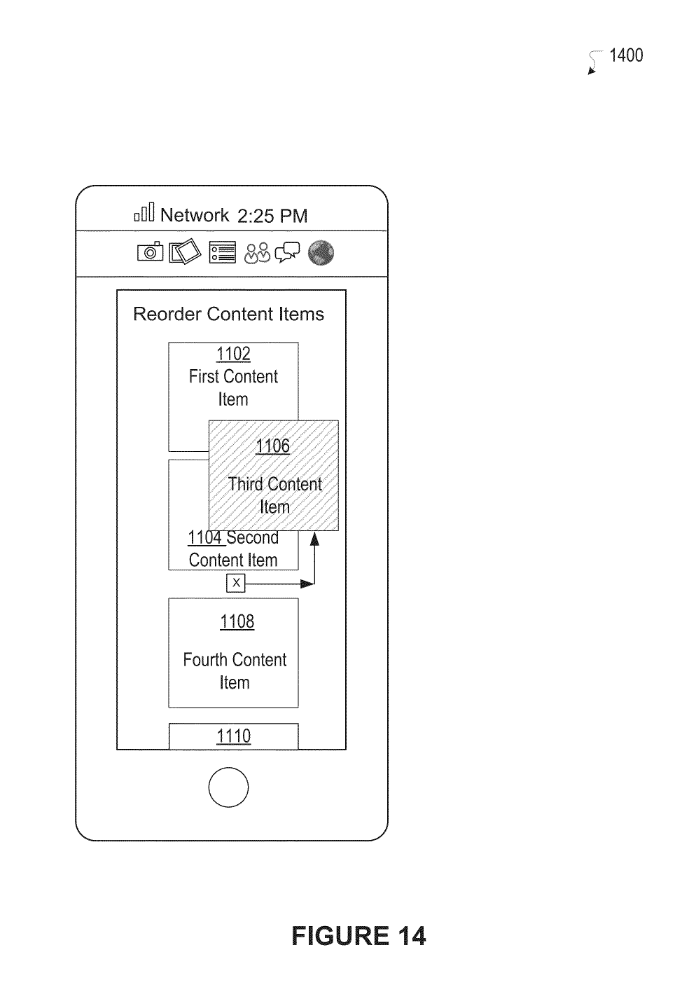

FIG. 14 illustrates an example screen 1400 of a user interface of a system that facilitates reordering of content items, according to an embodiment of the present disclosure. The screen 1400 reflects provision of a user gesture to move the third content item 1106 out of order. More specifically, a user has moved the third content item 1106 right (e.g., horizontally) to pull it away from the second content item 1104 and the fourth content item 1108. This horizontal movement may have been a horizontal swipe gesture or a horizontal drag. The space between the second content item 1104 and the fourth content item 1108 previously occupied by the third content item 1106 has closed after the third content item 1106 is pulled away. The user has also moved the third content item 1106 vertically and upwardly using a vertical motion gesture (e.g., a vertical swipe or vertical drag). As the third content item 1106 is moved in this manner, the screen 1400 is scrolled down to make the third content item 1106 appear as if it is moving up in the order of the content items.

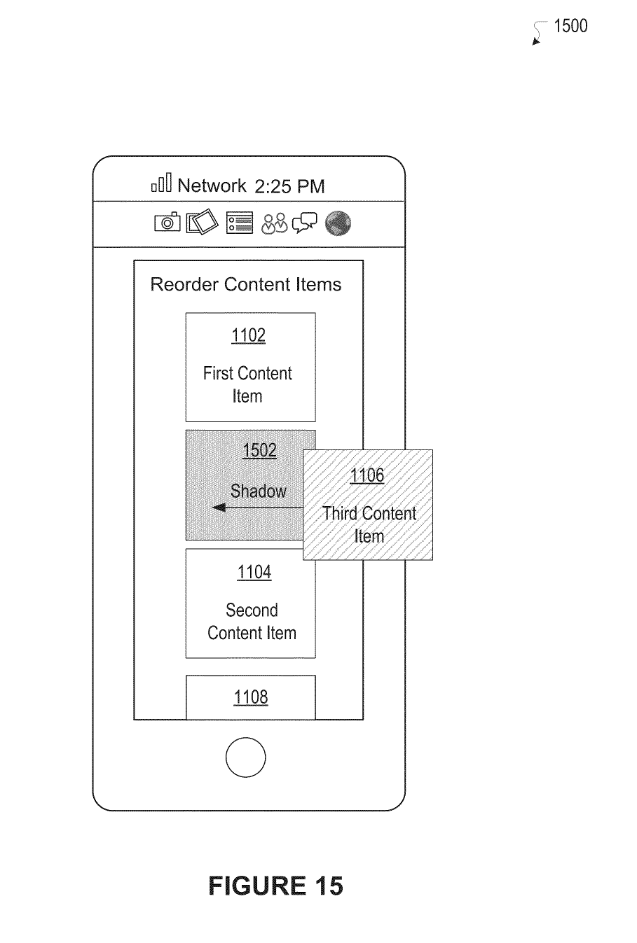

FIG. 15 illustrates an example screen 1500 of a user interface of a system that facilitates reordering of content items, according to an embodiment of the present disclosure. The user is moving the third content item 1106 left (e.g., horizontally) to insert the third content item 1106 between the first content item 1102 and the second content item 1104. The screen 1500 reflects a decision of the user to place the third content item 1106 between the first content item 1102 and the second content item 1104. In some embodiments, a shadow 1502 may automatically appear between the first content item 1102 and the second content item 1104 as the user moves the third content item 1106 to a selected position relative to the first content item 1102 and the second content item 1104. The shadow 1502 may indicate to the user that the third content item 1104 has been moved sufficiently to allow insertion between the first content item 1102 and the second content item 1104. In some embodiments, a shadow may appear whenever movement of a reference content item results in allowable insertion of the reference content item between two other content items. In an embodiment, an indicator of where the reference content item will land is shown using an opaque preview of the reference content item in the new position by moving adjacent content items apart.

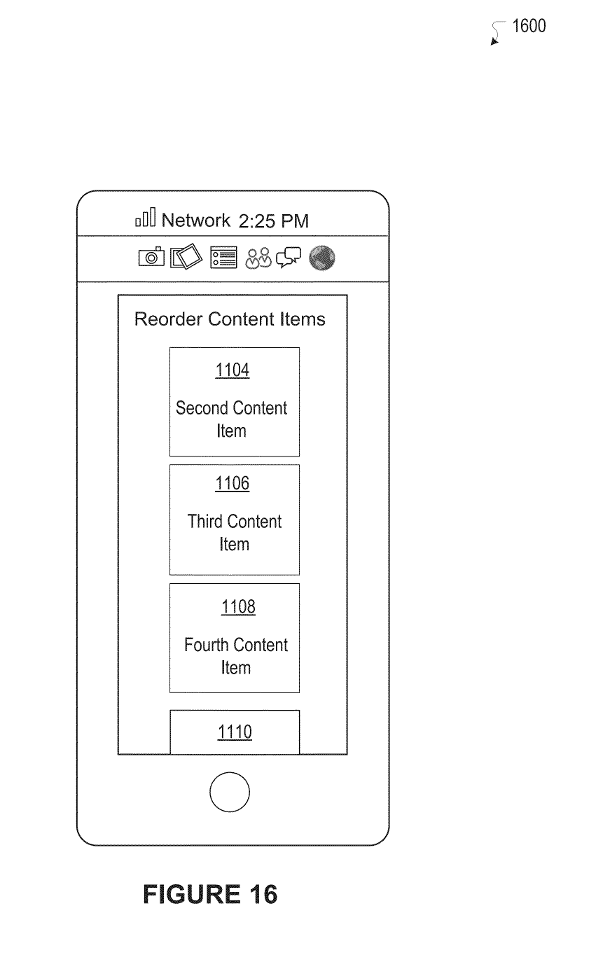

FIG. 16 illustrates an example screen 1600 of a user interface of a system that facilitates reordering of content items, according to an embodiment of the present disclosure. The screen 1600 shows the content reordering screen after the third content item 1106 has been inserted between the first content item 1102 and the second content item 1104.

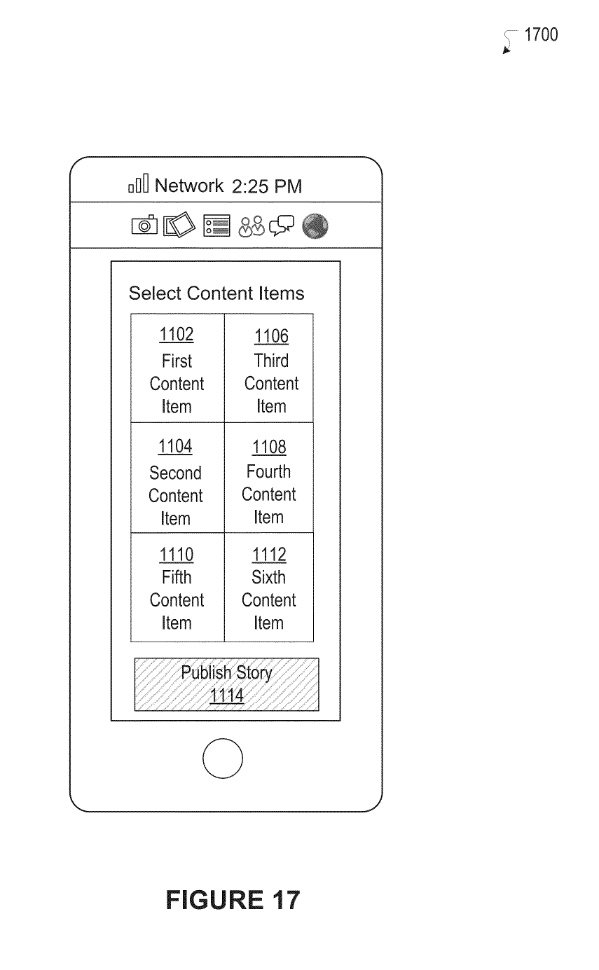

FIG. 17 illustrates an example screen 1700 of a user interface of a system that facilitates reordering of content items, according to an embodiment of the present disclosure. The screen 1700 illustrates the story creation screen after the third content item 1106 has been reranked and the order of the content items has been modified. In the screen 1700, the story publication button 1114 can be depressed by the user to publish the story to the user's social networking account. For instance, the story may be shared with friends or published to the user's feed.

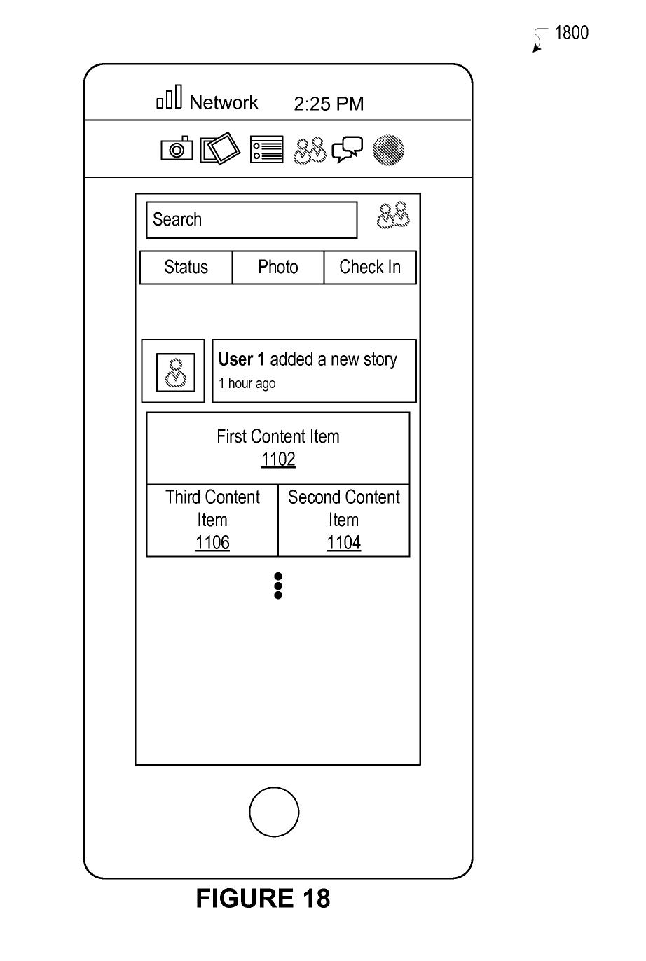

FIG. 18 illustrates an example screen 1800 of a user interface of a system that facilitates reordering of content items, according to an embodiment of the present disclosure. The screen 1800 may show a feed for another user associated with the user who created the story with the reranking of the third content item 1106. In the screen 1800, the first content item 1102, the third content item 1106, and the second content item 1104 appear in the feed of the other user according to the reranked ordering.

### Social Networking System—Example Implementation

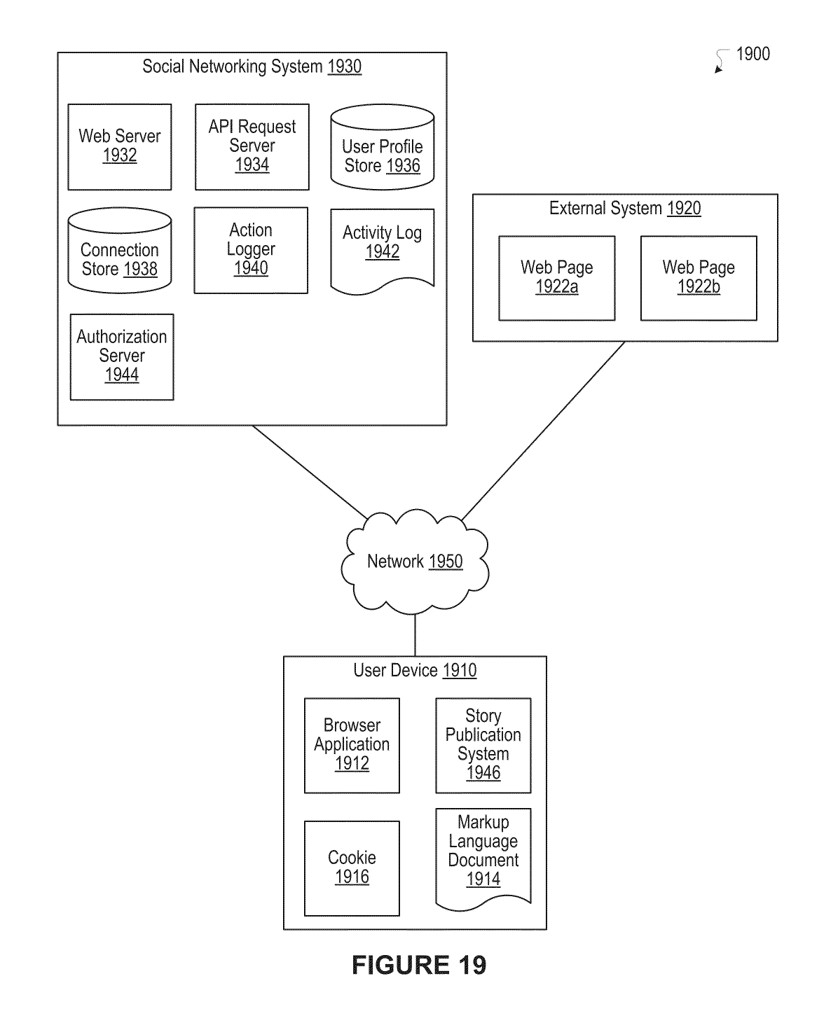

FIG. 19 illustrates a network diagram of an example system 1900 that can be utilized in various embodiments for enhanced video encoding, in accordance with an embodiment of the present disclosure. The system 1900 includes one or more user devices 1910, one or more external systems 1920, a social networking system 1930, and a network 1950. In an embodiment, the social networking service, provider, and/or system discussed in connection with the embodiments described above may be implemented as the social networking system 1930. For purposes of illustration, the embodiment of the system 1900, shown by FIG. 19, includes a single external system 1920 and a single user device 1910. However, in other embodiments, the system 1900 may include more user devices 1910 and/or more external systems 1920. In certain embodiments, the social networking system 1930 is operated by a social network provider, whereas the external systems 1920 are separate from the social networking system 1930 in that they may be operated by different entities. In various embodiments, however, the social networking system 1930 and the external systems 1920 operate in conjunction to provide social networking services to users (or members) of the social networking system 1930. In this sense, the social networking system 1930 provides a platform or backbone, which other systems, such as external systems 1920, may use to provide social networking services and functionalities to users across the Internet.

The user device 1910 comprises one or more computing devices that can receive input from a user and transmit and receive data via the network 1950. In one embodiment, the user device 1910 is a conventional computer system executing, for example, a Microsoft Windows compatible operating system (OS), Apple OS X, and/or a Linux distribution. In another embodiment, the user device 1910 can be a device having computer functionality, such as a smart-phone, a tablet, a personal digital assistant (PDA), a mobile telephone, etc. The user device 1910 is configured to communicate via the network 1950. The user device 1910 can execute an application, for example, a browser application that allows a user of the user device 1910 to interact with the social networking system 1930. In another embodiment, the user device 1910 interacts with the social networking system 1930 through an application programming interface (API) provided by the native operating system of the user device 1910, such as iOS and ANDROID. The user device 1910 is configured to communicate with the external system 1920 and the social networking system 1930 via the network 1950, which may comprise any combination of local area and/or wide area networks, using wired and/or wireless communication systems.

In one embodiment, the network 1950 uses standard communications technologies and protocols. Thus, the network 1950 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 1950 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 1950 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 1910 may display content from the external system 1920 and/or from the social networking system 1930 by processing a markup language document 1914 received from the external system 1920 and from the social networking system 1930 using a browser application 1912. The markup language document 1914 identifies content and one or more instructions describing formatting or presentation of the content. By executing the instructions included in the markup language document 1914, the browser application 1912 displays the identified content using the format or presentation described by the markup language document 1914. For example, the markup language document 1914 includes instructions for generating and displaying a web page having multiple frames that include text and/or image data retrieved from the external system 1920 and the social networking system 1930. In various embodiments, the markup language document 1914 comprises a data file including extensible markup language (XML) data, extensible hypertext markup language (XHTML) data, or other markup language data. Additionally, the markup language document 1914 may include JavaScript Object Notation (JSON) data, JSON with padding (JSONP), and JavaScript data to facilitate data-interchange between the external system 1920 and the user device 1910. The browser application 1912 on the user device 1910 may use a JavaScript compiler to decode the markup language document 1914.

The markup language document 1914 may also include, or link to, applications or application frameworks such as FLASH™ or Unity™ applications, the SilverLight™ application framework, etc.

In one embodiment, the user device 1910 also includes one or more cookies 1916 including data indicating whether a user of the user device 1910 is logged into the social networking system 1930, which may enable modification of the data communicated from the social networking system 1930 to the user device 1910.

The external system 1920 includes one or more web servers that include one or more web pages 1922a, 1922b, which are communicated to the user device 1910 using the network 1950. The external system 1920 is separate from the social networking system 1930. For example, the external system 1920 is associated with a first domain, while the social networking system 1930 is associated with a separate social networking domain. Web pages 1922a, 1922b, included in the external system 1920, comprise a markup language document 1914 identifying content and including instructions specifying formatting or presentation of the identified content.

The social networking system 1930 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 1930 may be administered, managed, or controlled by an operator. The operator of the social networking system 1930 may be a human being, an automated application, or a series of applications for managing content, regulating policies, and collecting usage metrics within the social networking system 1930. Any type of operator may be used.

Users may join the social networking system 1930 and then add connections to any number of other users of the social networking system 1930 to whom they desire to be connected. As used herein, the term “friend” refers to any other user of the social networking system 1930 to whom a user has formed a connection, association, or relationship via the social networking system 1930. For example, in an embodiment, if users in the social networking system 1930 are represented as nodes in the social graph, the term “friend” can refer to an edge formed between and directly connecting two user nodes.

Connections may be added explicitly by a user or may be automatically created by the social networking system 1930 based on common characteristics of the users (e.g., users who are alumni of the same educational institution). For example, a first user specifically selects a particular other user to be a friend. Connections in the social networking system 1930 are usually in both directions, but need not be, so the terms “user” and “friend” depend on the frame of reference. Connections between users of the social networking system 1930 are usually bilateral (“two-way”), or “mutual,” but connections may also be unilateral, or “one-way.” For example, if Bob and Joe are both users of the social networking system 1930 and connected to each other, Bob and Joe are each other's connections. If, on the other hand, Bob wishes to connect to Joe to view data communicated to the social networking system 1930 by Joe, but Joe does not wish to form a mutual connection, a unilateral connection may be established. The connection between users may be a direct connection; however, some embodiments of the social networking system 1930 allow the connection to be indirect via one or more levels of connections or degrees of separation.

In addition to establishing and maintaining connections between users and allowing interactions between users, the social networking system 1930 provides users with the ability to take actions on various types of items supported by the social networking system 1930. These items may include groups or networks (i.e., social networks of people, entities, and concepts) to which users of the social networking system 1930 may belong, events or calendar entries in which a user might be interested, computer-based applications that a user may use via the social networking system 1930, transactions that allow users to buy or sell items via services provided by or through the social networking system 1930, and interactions with advertisements that a user may perform on or off the social networking system 1930. These are just a few examples of the items upon which a user may act on the social networking system 1930, and many others are possible. A user may interact with anything that is capable of being represented in the social networking system 1930 or in the external system 1920, separate from the social networking system 1930, or coupled to the social networking system 1930 via the network 1950.

The social networking system 1930 is also capable of linking a variety of entities. For example, the social networking system 1930 enables users to interact with each other as well as external systems 1920 or other entities through an API, a web service, or other communication channels. The social networking system 1930 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 1930. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 1930 modifies edges connecting the various nodes to reflect the relationships and interactions.

The social networking system 1930 also includes user-generated content, which enhances a user's interactions with the social networking system 1930. User-generated content may include anything a user can add, upload, send, or “post” to the social networking system 1930. For example, a user communicates posts to the social networking system 1930 from a user device 1910. Posts may include data such as status updates or other textual data, location information, images such as photos, videos, links, music or other similar data and/or media. Content may also be added to the social networking system 1930 by a third party. Content “items” are represented as objects in the social networking system 1930. In this way, users of the social networking system 1930 are encouraged to communicate with each other by posting text and content items of various types of media through various communication channels. Such communication increases the interaction of users with each other and increases the frequency with which users interact with the social networking system 1930.

The social networking system 1930 includes a web server 1932, an API request server 1934, a user profile store 1936, a connection store 1938, an action logger 1940, an activity log 1942, and an authorization server 1944. In an embodiment of the invention, the social networking system 1930 may include additional, fewer, or different components for various applications. Other components, such as network interfaces, security mechanisms, load balancers, failover servers, management and network operations consoles, and the like are not shown so as to not obscure the details of the system.

The user profile store 1936 maintains information about user accounts, including biographic, demographic, and other types of descriptive information, such as work experience, educational history, hobbies or preferences, location, and the like that has been declared by users or inferred by the social networking system 1930. This information is stored in the user profile store 1936 such that each user is uniquely identified. The social networking system 1930 also stores data describing one or more connections between different users in the connection store 1938. The connection information may indicate users who have similar or common work experience, group memberships, hobbies, or educational history. Additionally, the social networking system 1930 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 1930, such as non-person entities, buckets, cluster centers, images, interests, pages, external systems, concepts, and the like are also stored in the connection store 1938.

The social networking system 1930 maintains data about objects with which a user may interact. To maintain this data, the user profile store 1936 and the connection store 1938 store instances of the corresponding type of objects maintained by the social networking system 1930. Each object type has information fields that are suitable for storing information appropriate to the type of object. For example, the user profile store 1936 contains data structures with fields suitable for describing a user's account and information related to a user's account. When a new object of a particular type is created, the social networking system 1930 initializes a new data structure of the corresponding type, assigns a unique object identifier to it, and begins to add data to the object as needed. This might occur, for example, when a user becomes a user of the social networking system 1930, the social networking system 1930 generates a new instance of a user profile in the user profile store 1936, assigns a unique identifier to the user account, and begins to populate the fields of the user account with information provided by the user.

The connection store 1938 includes data structures suitable for describing a user's connections to other users, connections to external systems 1920 or connections to other entities. The connection store 1938 may also associate a connection type with a user's connections, which may be used in conjunction with the user's privacy setting to regulate access to information about the user. In an embodiment of the invention, the user profile store 1936 and the connection store 1938 may be implemented as a federated database.

Data stored in the connection store 1938, the user profile store 1936, and the activity log 1942 enables the social networking system 1930 to generate the social graph that uses nodes to identify various objects and edges connecting nodes to identify relationships between different objects. For example, if a first user establishes a connection with a second user in the social networking system 1930, user accounts of the first user and the second user from the user profile store 1936 may act as nodes in the social graph. The connection between the first user and the second user stored by the connection store 1938 is an edge between the nodes associated with the first user and the second user. Continuing this example, the second user may then send the first user a message within the social networking system 1930. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 1930 (or, alternatively, in an image maintained by another system outside of the social networking system 1930). The image may itself be represented as a node in the social networking system 1930. This tagging action may create edges between the first user and the second user as well as create an edge between each of the users and the image, which is also a node in the social graph. In yet another example, if a user confirms attending an event, the user and the event are nodes obtained from the user profile store 1936, where the attendance of the event is an edge between the nodes that may be retrieved from the activity log 1942. By generating and maintaining the social graph, the social networking system 1930 includes data describing many different types of objects and the interactions and connections among those objects, providing a rich source of socially relevant information.

The web server 1932 links the social networking system 1930 to one or more user devices 1910 and/or one or more external systems 1920 via the network 1950. The web server 1932 serves web pages, as well as other web-related content, such as Java, JavaScript, Flash, XML, and so forth. The web server 1932 may include a mail server or other messaging functionality for receiving and routing messages between the social networking system 1930 and one or more user devices 1910. The messages can be instant messages, queued messages (e.g., email), text and SMS messages, or any other suitable messaging format.

The API request server 1934 allows one or more external systems 1920 and user devices 1910 to call access information from the social networking system 1930 by calling one or more API functions. The API request server 1934 may also allow external systems 1920 to send information to the social networking system 1930 by calling APIs. The external system 1920, in one embodiment, sends an API request to the social networking system 1930 via the network 1950, and the API request server 1934 receives the API request. The API request server 1934 processes the request by calling an API associated with the API request to generate an appropriate response, which the API request server 1934 communicates to the external system 1920 via the network 1950. For example, responsive to an API request, the API request server 1934 collects data associated with a user, such as the user's connections that have logged into the external system 1920, and communicates the collected data to the external system 1920. In another embodiment, the user device 1910 communicates with the social networking system 1930 via APIs in the same manner as external systems 1920.

The action logger 1940 is capable of receiving communications from the web server 1932 about user actions on and/or off the social networking system 1930. The action logger 1940 populates the activity log 1942 with information about user actions, enabling the social networking system 1930 to discover various actions taken by its users within the social networking system 1930 and outside of the social networking system 1930. Any action that a particular user takes with respect to another node on the social networking system 1930 may be associated with each user's account, through information maintained in the activity log 1942 or in a similar database or other data repository. Examples of actions taken by a user within the social networking system 1930 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 1930, the action is recorded in the activity log 1942. In one embodiment, the social networking system 1930 maintains the activity log 1942 as a database of entries. When an action is taken within the social networking system 1930, an entry for the action is added to the activity log 1942. The activity log 1942 may be referred to as an action log.

Additionally, user actions may be associated with concepts and actions that occur within an entity outside of the social networking system 1930, such as an external system 1920 that is separate from the social networking system 1930. For example, the action logger 1940 may receive data describing a user's interaction with an external system 1920 from the web server 1932. In this example, the external system 1920 reports a user's interaction according to structured actions and objects in the social graph.

Other examples of actions where a user interacts with an external system 1920 include a user expressing an interest in an external system 1920 or another entity, a user posting a comment to the social networking system 1930 that discusses an external system 1920 or a web page 1922a within the external system 1920, a user posting to the social networking system 1930 a Uniform Resource Locator (URL) or other identifier associated with an external system 1920, a user attending an event associated with an external system 1920, or any other action by a user that is related to an external system 1920. Thus, the activity log 1942 may include actions describing interactions between a user of the social networking system 1930 and an external system 1920 that is separate from the social networking system 1930.

The authorization server 1944 enforces one or more privacy settings of the users of the social networking system 1930. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 1920, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 1920. One embodiment allows the specification of the set of entities to comprise an enumeration of entities. For example, the user may provide a list of external systems 1920 that are allowed to access certain information. Another embodiment allows the specification to comprise a set of entities along with exceptions that are not allowed to access the information. For example, a user may allow all external systems 1920 to access the user's work information, but specify a list of external systems 1920 that are not allowed to access the work information. Certain embodiments call the list of exceptions that are not allowed to access certain information a “block list”. External systems 1920 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 1944 contains logic to determine if certain information associated with a user can be accessed by a user's friends, external systems 1920, and/or other applications and entities. The external system 1920 may need authorization from the authorization server 1944 to access the user's more private and sensitive information, such as the user's work phone number. Based on the user's privacy settings, the authorization server 1944 determines if another user, the external system 1920, an application, or another entity is allowed to access information associated with the user, including information about actions taken by the user.

The user device 1910 can include a story publication system 1946. The story publication system 1946 can facilitate effective publication of content items by allowing a user to reorder content items according to a specific narrative of a story the user is trying to tell with the content items. The story publication system 1946 can further allow a user to enter captions, titles, tags, maps, and other metadata associated with a story. The story publication system 1946 can include a story publication user interface module, having the story publication user interface features described herein, and a story publication management module, having the story publication management features descried herein. In some embodiments, the story publication system 1946 can be implemented as the story publication system 102 of FIG. 1.

### Hardware Implementation

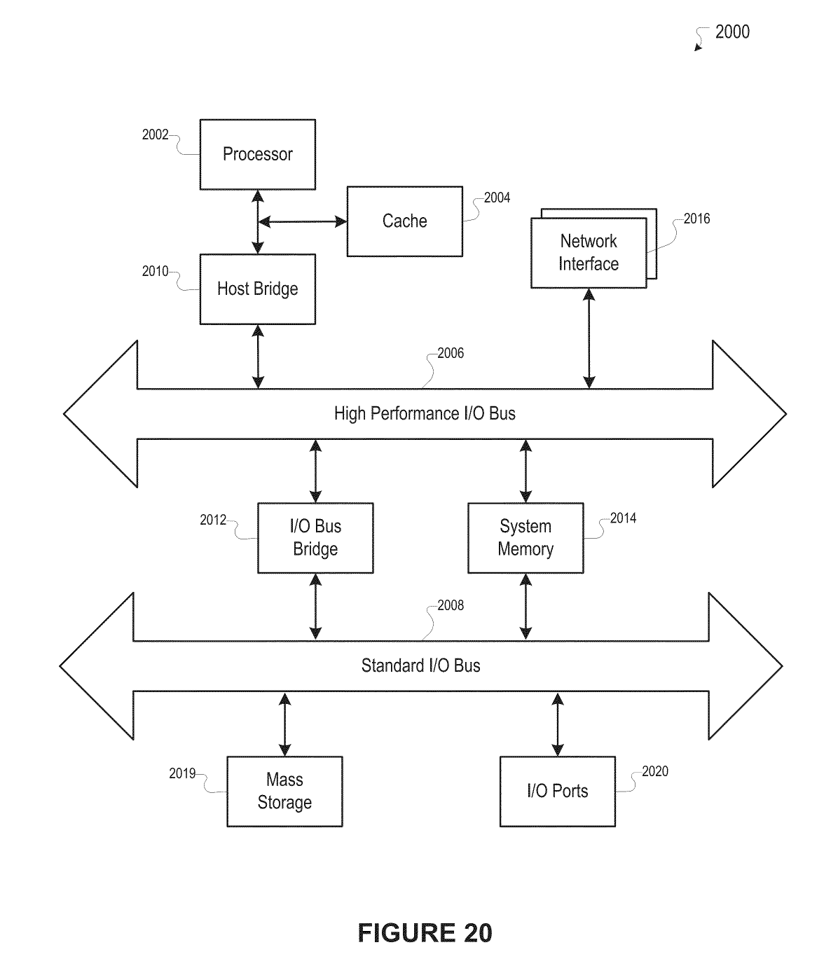

The foregoing processes and features can be implemented by a wide variety of machine and computer system architectures and in a wide variety of network and computing environments. FIG. 20 illustrates an example of a computer system 2000 that may be used to implement one or more of the embodiments described herein in accordance with an embodiment of the invention. The computer system 2000 includes sets of instructions for causing the computer system 2000 to perform the processes and features discussed herein. The computer system 2000 may be connected (e.g., networked) to other machines. In a networked deployment, the computer system 2000 may operate in the capacity of a server machine or a client machine in a client-server network environment, or as a peer machine in a peer-to-peer (or distributed) network environment. In an embodiment of the invention, the computer system 2000 may be the social networking system 1930, the user device 1910, and the external system 1920, or a component thereof. In an embodiment of the invention, the computer system 2000 may be one server among many that constitutes all or part of the social networking system 1930.

The computer system 2000 includes a processor 2002, a cache 2004, and one or more executable modules and drivers, stored on a computer-readable medium, directed to the processes and features described herein. Additionally, the computer system 2000 includes a high performance input/output (I/O) bus 2006 and a standard I/O bus 2008. A host bridge 2010 couples processor 2002 to high performance I/O bus 2006, whereas I/O bus bridge 2012 couples the two buses 2006 and 2008 to each other. A system memory 2014 and one or more network interfaces 2016 couple to high performance I/O bus 2006. The computer system 2000 may further include video memory and a display device coupled to the video memory (not shown). Mass storage 2018 and I/O ports 2020 couple to the standard I/O bus 2008. The computer system 2000 may optionally include a keyboard and pointing device, a display device, or other input/output devices (not shown) coupled to the standard I/O bus 2008. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 2000, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 2000 are described in greater detail below. In particular, the network interface 2016 provides communication between the computer system 2000 and any of a wide range of networks, such as an Ethernet (e.g., IEEE 802.3) network, a backplane, etc. The mass storage 2018 provides permanent storage for the data and programming instructions to perform the above-described processes and features implemented by the respective computing systems identified above, whereas the system memory 2014 (e.g., DRAM) provides temporary storage for the data and programming instructions when executed by the processor 2002. The I/O ports 2020 may be one or more serial and/or parallel communication ports that provide communication between additional peripheral devices, which may be coupled to the computer system 2000.

The computer system 2000 may include a variety of system architectures, and various components of the computer system 2000 may be rearranged. For example, the cache 2004 may be on-chip with processor 2002. Alternatively, the cache 2004 and the processor 2002 may be packed together as a “processor module”, with processor 2002 being referred to as the “processor core”. Furthermore, certain embodiments of the invention may neither require nor include all of the above components. For example, peripheral devices coupled to the standard I/O bus 2008 may couple to the high performance I/O bus 2006. In addition, in some embodiments, only a single bus may exist, with the components of the computer system 2000 being coupled to the single bus. Furthermore, the computer system 2000 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 2000 that, when read and executed by one or more processors, cause the computer system 2000 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 2000, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 2002. Initially, the series of instructions may be stored on a storage device, such as the mass storage 2018. However, the series of instructions can be stored on any suitable computer readable storage medium. Furthermore, the series of instructions need not be stored locally, and could be received from a remote storage device, such as a server on a network, via the network interface 2016. The instructions are copied from the storage device, such as the mass storage 2018, into the system memory 2014 and then accessed and executed by the processor 2002. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 2000 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
highlighting, by a computing system, a reference content item of a plurality of content items associated with a story in response to a selection of the reference content item, the plurality of content items having a first order;
reranking the reference content item relative to the plurality of content items in response to user input to create a second order of the plurality of content items; and
publishing the story using the second order of the plurality of content items.

2. The computer-implemented method of claim 1, wherein the first order corresponds to an order the content items were uploaded for the story.

3. The computer-implemented method of claim 1, further comprising generating a content reordering screen in response to the selection of the reference content item in a story creation screen.

4. The computer-implemented method of claim 3, wherein the content reordering screen displays at least a portion of the plurality of content items in a vertical format optimized for viewing in a viewport of a mobile device.

5. The computer-implemented method of claim 1, wherein each of the plurality of content items comprises one or more of: digital images, digital audio, digital video, map data, hashtags, and social tags.

6. The computer-implemented method of claim 1, further comprising scrolling the plurality of content items in a content reordering screen.

7. The computer-implemented method of claim 6, wherein the scrolling occurs at scrolling speeds based at least in part on a distance between a position of a cursor or touchpoint and an initial position of the reference content item.

8. The computer-implemented method of claim 1, wherein reranking the reference content item comprises:
identifying an initial rank of the reference content item;
identifying an insertion location between a first content item and a second content item into which the user input instructs insertion of the reference content item; and
updating the rank of the reference content item based at least in part on the identified insertion location.

9. The computer-implemented method of claim 8, further comprising updating a rank of at least a portion of the plurality of content items other than the reference content item.

10. The computer-implemented method of claim 1, wherein highlighting the reference content item comprises shading the reference content item in a content reordering screen.

11. The computer-implemented method of claim 1, wherein the selection comprises a long press.

12. The computer-implemented method of claim 1, wherein the selection comprises a double-click or a right-click.

13. The computer-implemented method of claim 1, wherein publishing the story comprises sharing the story.

14. The computer-implemented method of claim 1, wherein publishing the story comprises at least one of publishing the story in a feed, storing the story locally, or storing the story on a server.

15. The computer-implemented method of claim 1, wherein selection of the reference content item is associated with a first screen and reranking of the reference content item is associated with a second screen.

16. The computer-implemented method of claim 1, wherein the user input is applied to a touchscreen display.

17. The computer-implemented method of claim 1, wherein the computer-implemented method is implemented on a mobile device.

18. The computer-implemented method of claim 1, wherein the computer-implemented method is implemented on an application associated with a social networking service or a social media service.

19. A system comprising:
at least one processor; and
a memory storing instructions that, when executed by the at least one processor, cause the system to perform:
highlighting a reference content item of a plurality of content items associated with a story in response to a selection of the reference content item, the plurality of content items having a first order;
reranking the reference content item relative to the plurality of content items in response to user input to create a second order of the plurality of content items; and
publishing the story using the second order of the plurality of content items

20. A non-transitory computer-readable storage medium including instructions that, when executed by at least one processor of a computing system, cause the computing system to perform:
highlighting a reference content item of a plurality of content items associated with a story in response to a selection of the reference content item, the plurality of content items having a first order;
reranking the reference content item relative to the plurality of content items in response to user input to create a second order of the plurality of content items; and
publishing the story using the second order of the plurality of content items.
